(19) United States
(12) Patent Application Publication
(10) Pub. No.: US 2005/0079379 A1
(43) Pub. Date: Apr. 14, 2005

(54) Enhancement of barrier fabrics with breathable films and of face masks and filters with novel fluorochemical electret reinforcing treatment

(75) Inventors: Larry C. Wadsworth, Knoxville, TN (US); Peter Ping-Yi Tsai, Knoxville, TN (US)

Correspondence Address: JENKINS & WILSON, PA, 3100 TOWER BLVD, SUITE 1400, DURHAM, NC, 27707, US

(73) Assignee: University of Tennessee Research Foundation

(21) Appl. No.: 10/915,808

(22) Filed: Aug. 11, 2004

Related U.S. Application Data
(60) Provisional application No. 60/494,343, filed on Aug. 11, 2003.
(60) Provisional application No. 60/494,344, filed on Aug. 11, 2003.

(51) Int. Cl. A62B 7/10

(52) U.S. Cl. 428/684

(57) ABSTRACT

A respirable one-ply, two-ply or multi-ply barrier fabric including one web comprising an electrostatically charged melt blown fibers nonwoven or a nanofiber/melt blown fibers nonwoven having a weak cationic emulsifier to reduce surface energy of the fibers so as to minimize penetration and wetting by oily mists and to thereby preserve the effectiveness of electrostatic charges applied to fibers. Also disclosed is a two-layer or multi-ply barrier fabric which has at least one barrier fabric layer which is impermeable to liquids such as water and body fluids, but which allows the transport of moisture vapor through the micropores or by chemical absorption of water through a monolithic membrane, which may have additional barrier layers to include melt blown and nanofiber/melt blown composites. One or more layers of the respirable barrier fabric or the moisture transporting microporous (MP) or monolithic (ML) films or combination thereof may contain an antimicrobial agent, fluorochemical or other protective finish, as well as any of the layers of the respirable filter fabric or any of the layers of the filter ensemble as well as any layer of the liquid barrier moisture transporting barrierfabrics. Furthermore, the protective fabrics may contain a porous or absorbent fabric or film on the body side for enhanced thermal comfort, and other additives may be included in the fabric ensembles such as activated carbon particles, or activated carbon particles, or other sorbents, or superabsorbents o to absorb odors or toxic chemicals.

### RELATED APPLICATIONS

This application claims the benefit of U.S. Provisional Patent Application Serial Nos. 60/494,343 and 60/494,344, both filed on Aug. 11, 2003, the disclosure of which is incorporated herein by reference in its entirety.

### TECHNICAL FIELD

This invention relates to breathable protective garment fabrics and to respirable face mask and respirator laminates which serve as barriers to microbial contaminated aerosols and liquid spills of infectious liquids and which may also decontaminate the dangerous aerosols and liquids.

### BACKGROUND ART AND DISCLOSURE OF THE INVENTION

Nonwoven webs (fabrics) are defined as “sheet” or web structures made by bonding and/or interlocking fibers, yarns or filaments by mechanical, thermal, chemical or solvent means.” These webs do not require the conversion of fibers to yarn. Nonwoven webs are also called bonded or engineered webs and are manufactured by processes other than spinning, weaving or knitting, hence the name “nonwovens.” The basic structure of all nonwovens is a web of fibers or filaments. A single type of fiber or filament may be the basic element of a nonwoven. Fibers that measured in centimeters or inches or fractions thereof are called staple fibers. In general filament fibers are measured in terms of kilometers or miles. In fact, filament fibers are not readily measured, as they may be many, many yards in length. In fibers the length must be considerably greater than the diameter, e.g., a length-to-width ratio of at least 100 and usually considerably higher. Cotton fibers may measure from less than ½ inch (o.27 cm) to more than 2 inches (5.08 cm) in length and have a typical length-to-width ratio of about 1400. Other natural fibers exhibit diameter ratios as follows: flax—1200; ramie—3000; and wool—3000. In the present application, the terms “fiber” or “fibers” are intended to include both short and long fibers, i.e. staple fibers and filament fibers, unless otherwise, specifically indicated by identifying the fibers as staple or filament. For example, spunbonded webs are formed of filament fibers, whereas, melt blown webs may include an assortment of fiber lengths. In nonwovens, the individual fibers may be in an organized or in a random arrangement. Tensile, elongation, and hand properties are imparted to the web by the type or types of bonding as well as fiber-to-fiber cohesion and reinforcement by its constituents. The technology for making nonwoven webs is based on the following primary elements: fibers of various lengths and diameters; a web arranged according to the method of forming and processing; the bonding of fibers within the web and reinforcement by its constituents. The variation of one or several elements in combination allows for the enormous range of nonwoven fiber types. Control of the type and length of the fibers and of the bonding, in combination with the selection of the manufacturing method, gives rise to a highly technical, yet extremely flexible combination of options.

### Medical Protective Drapes and Gowns

Traditionally, surgical gowns have been used by health care providers to ensure that patients do not contract any infection while receiving quality care in a hospital. The possibility of the health provider becoming infected by Human Immunodeficiency (HIV), Hepatitis B viruses (HBV) (“Facts and Fiction about Single-Use and Reusable Drapes and Gowns,” Brochure from INDA, Association of the Nonwovens Fabrics Industry, Cary, N.C., 1993; “How OSHA Regulations on Bloodborne Pathogens Protect you from AIDS and Hepatis,” Brochure from INDA, Cary, N.C., 1993) and more recently to Severe Acute Respiratory Syndrome (SARS) virus, as well as the threat of pathogens being spread by biological warfare and terrorism, has resulted in much increased concern for the safety of the health-care giver or the emergency responder, as well.

According to the Occupational Safety and Health Administration (OSHA), more than 5.6 million health care and public safety workers are at potential risk of being exposed to HIV and HBV (Occupational Exposure to Bloodborne Pathogens, OSHA 3127, 1992). This risk led OSHA to recognize the critical nature of blood borne pathogens and to issue a mandate on personal protective equipment (PPE) with the long-term goal of reducing the risk of occupational exposure to blood borne diseases. PPE is defined by OSHA as “specialized clothing or equipment worn by an employee for protection against a hazard.” Gowns, aprons, drapes, and masks are items included in this designation. PPE is considered to be “appropriate” only if it does not permit blood or other possibly infectious materials to pass to or reach the employee's clothes, street clothes, undergarments, skin, eyes, mouth, or other mucous membranes under normal conditions of use and duration of time which the protective equipment will be used (CFR Part 1910.1030 Occupational Exposure to Bloodborne Pathogens: Final Rule, Federal Register, Dec. 6, 1991). Extent and time exposure and other conditions during usage are criteria used in determining the efficacy of PPE for a certain task.

Although nonwoven webs and especially melt blown (MB) webs that are composed of ultra-fine fibers are much better barriers due to their more random orientation of fibers than conventional textiles such as knitted and woven fabrics, they are still not as effective as microporous (MP) and monolithic (ML) breathable films in liquid barrier protection. Commercially available MP films include Celgard 2400 polypropylene (PP) film; EXXAIRE® polyethylene film produced by Tredegar; Tetratex, a MP polytetrafluoroethylene (PTFE) produced by TetraTek Corporation and Gore-Tex® produced by W. L. Gore & Associates; Aptra Classic™ MP PP produced by RKW US, Inc., and other types of MP films. Breathable ML films generally absorb moisture away from a person's body and results in evaporative cooling when the moisture is absorbed through the non-pervious film and evaporates into the surroundings. Some commercial ML films use thermoplastic polyurethane (TPU) resins such as Estane® and Permax® breathable coatings produced Noveon Inc.; COPAs like PEBAX®; and COPE resins like Hytrel®. On the other hand, MP films serve as barriers to liquids in that they gave small tortuous pore channels through the film which are too small for most liquids such as water, body fluids and many organic chemicals to pass through the film, but allow moisture vapor to escape and provide thermal comfort for the wearer. MP films are defined as having a narrow pore size distribution in the submicron range, from 0.1 to 1.0 microns. The MP films can be made by a number of processes that include (a) dissolving polymers in solution followed by extraction of the solvent by water vapor; (b) stretching of a crystallizable polymer, which results in micro-sized tears; and (c) stretching of a mineral filled polyolefin. In recent years it has been widely known that 3-ply laminates consisting of an inner core of MP film and outer layers of SB or MB nonwovens will pass the test for resistance to penetration of synthetic blood (ASTM F1670); whereas, SB/MB/SB (SMS) laminates generally will not pass this test. Only recently have manufacturers begun to make the claim that laminates of MP film with SB and MB nonwovens pass the more rigorous test for resistance to blood-borne virus during the synthetic blood penetration test (ASTM F1671) (Wadsworth, L. C. and H. C. Allen, Jr., “Development of Highly Breathable and Effective Blood/Viral Barrier Laminates of Microporous Films, Staple Fibers and Nonwovens,” J. of Coated Fabrics, Vol 28, 1998).

Nonwoven webs have found acceptance in the medical industry as disposable substitutes for the prior art reusable cotton examination gowns, surgical gowns, surgical drapes, face masks, shoe covers, sterilization wrap and other products to the extent that this market for nonwoven products is estimated to exceed one billion dollars annually.

### Face Masks and Respirators

Surgical face masks have greatly improved since their first use in the late 19^{th} Century when medical science learned that germs cause infection and disease. The major innovations have involved replacing the merely cosmetic woven filter cloth with glass fiber and later with electrostatically charged non-glass polypropylene microfiber nonwovens. Likewise respirators have evolved and in many cases may be used interchangeably with surgical masks depending on the applications. The 3-ply surgical masks, with inner and outer facings with a microfiber filter media in the center, are usually rectangular and flat and must be tied or secure around the back of the head with bands or elastic straps. Even though surgical masks may have metal or plastic strips that are pinched around the nose for a better fit, cup-shaped masks or respirators with the proper filter rating, may provide better fit, but breathing is likely to be less comfortable. With the advent of dangerous infectious diseases which are readily spread in the air, such as Aids, Hepatitis and Severe Acute Respiratory Syndrome (SARS) virus, the function of face masks and respirators has evolved to protect both the wearer and the people around him. Furthermore, filter media in respirators may contain activated carbon and other sorbents to remove harmful gases from inhaled air. Test standards have been developed for rating the safety of face masks and respirators and will be discussed in this invention as well.

During the 1960s, the American Association of Operating Room Nurses (AORN) first established the standard for the minimal acceptable filtration efficiency of 95% in the In Vivo bacterial filtration efficiency (In Vivo BFE) in which a person places his head in a test apparatus containing the FM and simulates coughing by repeatedly saying “chew bite.” The person's natural germ-containing aerosol emanating from his respiratory system and mouth, which penetrated the FM was collected on an ultra-fine filter and was cultured, usually for 24 hours, and the number of bacterial colonies were counted and compared to a control in which no FM was placed in the specimen holder to calculate the filtration efficiency.

Later the In Vitro BFE procedure was adopted by AORN, in which the human subject was replaced by an air activated nebulizer containing a suitable concentration of Staphylococcus aureus bacteria in water to form a minimum of 1000 colony forming units on the micronaire filter when no FM was in the sample holder. The test was then run for a specified time with the FM in the holder and the In vitro BFE was calculated by first subtracting the number of bacterial colonies obtained with the FM in line compared to the count obtained when no FM was in line and dividing the quotient by the number of colonies with no filter and multiplying by 100. Then this value was subtracted from 100 to obtain the In vitro BFE. The pressure drop across the filter was also recorded and reported in mm or inches of water. It was specified in the test procedure as to whether the FM was tested as a flat fabric or in the shape of a simulated face in the sample holder (Johnson and Johnson Standard Test Number 9039, “In Vitro Bacterial Filtration Efficiencies of Face Masks,” issued, Feb. 2, 1978). Currently the two standards are primarily referenced for determining In Vitro BFE are ASTM F 2101 (ASTM F2101, “Standard Test Method for Evaluating the Bacterial Filtration Efficiency of Medical Materials, Using a Biological Aerosol”) and Military Standard M11-M 36954C (U.S. Military Standard M11-M36954C, “Military Specification, Mask, Surgical, Disposable”).

Both standards state that an acceptable BFE is 95% or greater and specify the use of S. aureus bacteria in an aqueous aerosol as described above using a Chicago (collision) Nebulizer with a flow rate of 1 cubic foot per minute. The Military Standard and ASTM F 21 (ASTM F2100-03a, “Standard Specification for Performance of Materials Used in Medical Face Masks”) also require that Δp across the flat mask or cup-shaped mask be performed separately from the BFE test by a vacuum method in which air is pumped through the sample at a flow rate of 8 l/min and the Δp should be no more than 5.0 mm water.

In the late 1970s this lead inventor, as an R&D scientist with Johnson & Johnson Surgikos Company led a successful program to replace the glass fiber filter media with melt blown (MB) polypropylene (PP). To achieve 95% In vitro BFE, it was necessary to electrostatically charge the MB filter media (Wadsworth, Larry C. and Solomon P. Hersh, Raleigh, N.C., “Method of Making Fibrous Electrets,” U.S. Pat. No. 4,375,718, assigned to Surgikos, Inc., issued Mar. 8, 1983). Latex-bonded dry-laid and wet-laid nonwovens with fiber contents viscose rayon, pulp or blends of cellulosic and synthetic fibers were utilized for the outer and inner facings, with the filter media in the center. By the late 1980s, virtually all surgical FMs consisted of an electrostatically charged MB PP filter media core (Wadsworth, Larry C. and Solomon P. Hersh, Raleigh, N.C., “Method of Making Fibrous Electrets,” U.S. Pat. No. 4,375,718, assigned to Surgikos, Inc., issued Mar. 8, 1983; Kubik, Donald A. and Charles I. Davis, “Melt-Blown Fibrous Electrets,” U.S. Pat. No. 4,215,682, assigned to Minnesota Mining and Manufacturing Company, issued Aug. 5, 1980; Klasse, P. T. A. and Jan van Tumhout, “Method for Manufacturing an Electret Filter Media,” U.S. Pat. No. 4,588,537, issued May 13, 1986) with pigmented SB PP on the outside and un-pigmented (white) SB PP on the body side. In 1995 and 1997, Wadsworth and Tsai obtained patents, for much improved cold electrostatic charging (Tantret™) technology (Tsai, P. P. and L. C. Wadsworth, “Method and Apparatus for the Electrostatic Charging of a Web or Film,” U.S. Pat. No. 5,401,446, assigned to The University of Tennessee Research Corporation (UTRC), issued Mar. 28, 1995; Wadsworth, L. C. and P. P. Tsai, “Method and Apparatus for the Electrostatic Charging of a Web or Film,” U.S. Pat. No. 5,686,050, assigned to UTRC, issued Nov. 11, 1997) assigned to The University of Tennessee Research Foundation (UTRF), which enabled the charged MB PP filter media in FMs and respirators to filter greater than 95% of particles with a diameter of 0.1 μm, which has been licensed to more than 20 companies world-wide. Such small particles are produced in laser surgery and concerns about the transmission of Aids and Hepatitis during surgery prompted the demand for high filtration efficiency to particles which could contain viruses.

### Construction of Face Masks and Respirators

Today, face masks (FMs) are typically composed of three layers, as illustrated in FIG. 2, with an outer layer (OL) of 12-25 g/m² spunbond (SB) PP, a center of 15-30 g/m² of electrostatically charged MB PP, and a body-side (BS) layer of 12-25 g/m² SB PP. Generally, face masks (e.g. surgical face masks and dust masks) are not bonded together and are only bonded on the edges of the face mask (FM) being fabricated by either sewing (FIG. 3, FIG. 3a, FIG. 3b, and FIG. 6), or preferably by ultrasonic bonding. Nevertheless, the FM laminates may be thermally or ultrasonically bonded (FIG. 4 and FIG. 11) together by a “spot welding” technique which does not fuse enough of the laminate together to excessively increase the pressure drop across the filter and make it difficult for one to breathe easily through the fabric, or to cause pin holes to form in the laminate and thereby increase the risk of harmful particles penetrating through the FM. However, FM laminate layers may be thermally fused together to produce a pre-formed cup-shaped mask or respirator, which may be held firmly, yet comfortably against the mouth to ensure that no or minimal leakage occurs where the edges of the cup-shaped mask contacts the human face. In fact a non-air-leaking rubbery or spongy layer may be attached around the edges of the cup mask to assure both a comfortable fit and non-leakage. An example with this innovation is the Willson 5000 Series respirator (Dalloz Safety Ltd., Hampshire RG27 9HX, United Kingdom, Willson 5000 Series Brochure). Respirators may also be fitted with exhalation valves which open when exhaling but which close for a tight seal when inhaling (FIG. 4b). European standards for respirators, EN 149:2001/Standard AS/NZS 1716:1994 require that the laminate construction must be able to be welded ultrasonically, as illustrated in FIG. 1, FIG. 2 and in the FIG. 11 process schematic, and that the thickness of the filter media must be as small as possible in order to obtain good welding of the mask with the media (FFP1 Media [Standard EN 149: 2001/Standard AS/NZS 1716: 1994], summary document and specifications by Bacou-Dalloz France; FFP2 Media [EN 149: 2001 Standard/AS/NZS 1716: 1994 Standard], summary document and specifications by Bacou-Dalloz France; FFP3 Media [EN 149: 2001 Standard], summary document and specifications by Bacou-Dalloz France). Typically to produce a cup mask with the required filtration efficiency (FE) and not too much pressure drop (ΔP), coarser and lower bulk density components, including MB media with larger fiber diameters and pores, may be used for spot thermal bonding or spot ultrasonic bonding of three-dimensionally shaped mask to meet the required end-use specifications in terms of FE, Δp and proper fitting to the face. Examples of cup-type face masks and respirators are readily found on the internet (NIOSH/NPPTL/Concept for SBRN Full Facepiece APR Standard, Sep. 16, 2002, Website: httD://www.cdc.gov/niosh/npptl/npptlrespfact.html; Respirators/NIOSH Topic Page, Website: http://www.cdc.gov/niosh/topics/respirators/;
Air filtration, filtration, and filtration system at 3m. com, Website: http://www.3m .com/occsafety/html/respirators.html;
Dust Masks-Masks/Respirators, Website: http://store.yahoo.com/pks-store/dustmasks.html;
INTERSAFE-Safety & First Aid products. Buy OnLine. Safety Glasses, Gloves, Masks, Website: http://www.probuy.net/dir/73.html)
   Dalloz Safety Ltd., Hampshire RG27 9HX, United Kingdom, Willson 4000 Series Brochure).

Alternatively, 3-D shapes may be fabricated without fusing or shaping a cup-type mask in a mold, by ultrasonically or otherwise seaming and bonding the structure together, as exemplified in the Willson 4000 Series flat fold (FIG. 4, FIG. 4a, FIG. 4b, FIG. 7, FIG. 7a) respirator (Dalloz Safety Ltd., Hampshire RG27 9HX, United Kingdom, Willson 4000 Series Brochure). In all of the examples, one or more odor or toxic gas absorbing component layers may be incorporated into the filter structures at appropriate locations within the cross-section of the filter to provide additional protection and comfort, without excessive pressure drop for the particular hazardous environment. A method has been patented by Moldex-Metric for producing carbon loaded filter materials by melt blowing a sandwiched structure incorporating activated carbon (Centaur 80×325 mesh, from Calgon Corp.) into melt blown media in which as much as 80 g/m² carbon is inserted into a 30 g/m² MB PP structure (Hershelman, J. W., “Method for producing filter material formed of melt-blown non-woven mat sandwiching additional material”). Respirators are available with activated carbon providing relief to different levels of organic vapors, acid gases and other irritating or harmful gases (Dalloz Safety Ltd., Hampshire RG27 9HX, United Kingdom, Willson 5000 Series Brochure, NIOSH/NPPTL/Concept for SBRN Full Facepiece APR Standard, Sep. 16, 2002, Website: http://www.cdc.gov/niosh/npptl/npptlrespfact.html; Respirators/NIOSH Topic Page, Website: http://www.cdc.gov/niosh/topics/respirators/). Concerns over terrorism have prompted the development of masks to provide protection for people and first responders in threat environments. For example, a Quick Escape Mask containing activated carbon is being sold by FMJ ChemBio, Inc. which is advertised to filter toxic smoke, biological and chemical agents for 15 minutes while one leaves the danger zone (ChemBio-Quick Escape Mask-biological or chemical protection, Website: http://www.fmjchembio.com/). Air purifying respirators are marketed by 3M for first responders (Air filtration, filtration, and filtration system at 3m.com, Website: http://www.3m.com/occsafety/html/respirators.html). Respirators with replaceable cartridges designed for different types of particulate and gas absorption may be made of impermeable rubber or plastic shaped to fit the face with secure attachments for the filter cartridges and exhalation valve (INTERSAFE-Safety & First Aid products. Buy OnLine. Safety Glasses, Gloves, Masks, Website: http://www.probuy.net/dir/73.html).

### Filter Testing and Standards

Surgical Face Masks

As noted above, currently the two standards are primarily referenced for determining In Vitro BFE are ASTM F 2101 and Military Standard M11-M36954C. Both standards state that an acceptable BFE is 95% or greater and specify the use of S. aureus bacteria in an aqueous aerosol as described above using a Chicago Nebulizer with a flow rate of 1 cubic foot per minute. The Military Standard and ASTM F 2100-03a (ASTM F2100-03a, “Standard Specification for Performance of Materials Used in Medical Face Masks”) also require that Δp across the flat mask or cup-shaped mask be performed separately from the BFE test by a vacuum method in which air is pumped through the sample at a flow rate of 8 l/min and the Δp should be no more than 5.0 mm water.

NIOSH Respirator Standards

The Center for Disease Control (CDC) recommends that health-care workers protect themselves from airborne diseases such as SARS or Tuberculosis by wearing a fit-tested respirator which is at least as protective as an approved N-95 respirator. An N-95 respirator is one of nine types of disposable particulate respirators described below in Table 1. The N series of respirators have no resistance to oil and may filter much less than the rated efficiency if exposed to oil or aerosols containing oil droplets. The R series offer some resistance to oil and the P series are strongly resistant to oil (NIOSH Approved Disposable Particulate Respirators, Website: http://www.cdc.gov/niosh/npptl/respirators/disp part/particlist.html).

TABLE 1
Type and Description of NIOSH-Approved Respirators

| Type | Description |
|---|---|
| N95 | Filters at least 95% of airborne particles. Not resistant to oil. |
| N99 | Filters at least 99% of airborne particles. Not resistant to oil. |
| N100 | Filters at least 99.7% of airborne particles. Not resistant to oil. |
| R95 | Filters at least 95% of airborne particles. Somewhat resistant to |
| | oil. |
| R99* | Filters at least 99% of airborne particles. Somewhat resistant to |
| | oil. |
| R100* | Filters at least 99.7% of airborne particles. Somewhat resistant to |
| | oil. |
| P95 | Filters at least 95% of airborne particles. Strongly resistant to |
| | oil. |
| P99* | Filters at least 99% of airborne particles. Strongly resistant to |
| | oil. |
| P100 | Filters at least 99.7% of airborne particles. Strongly resistant to |
| | oil. |

*No NIOSH approvals are held by this type of disposable particulate respirator

The disposable respirator containing N95 filtering media must meet the requirements of the NIOSH Standard 42 CFR Part 84. The N95 filter is tested using the TSI Model 8130 Automated Filter Tester or an equivalent instrument with a forward light scattering detector. The challenge aerosol consists of solid NaCl particles with a median diameter of 0.075 μm and with a maximum concentration of 200 mg/cm³. The aerosol flow rate is 85 l/min and the minimum filtering area is 150 cm² for inhalation and 165 cm² for exhalation. The filtering resistance must be a maximum of 35 mm water column for inhalation and 25 mm water for exhalation.

European Standards for Respirators

European Standard EN 149:2001/AS/NZS 1716:1994 provides standards and test procedures for single-use respirators containing three different types of filter media:FFP1, FFP2, and FFP3. With all three standards, the filter “media must be homogeneous, uniform, without holes nor melted material.” Furthermore, the laminate construction must be able to be welded ultrasonically, and that the thickness of the filter media must be as small as possible in order to obtain good welding of the mask with the media. The testing protocols for FFP1, FFP2 and FFP3 all require an aerosol flow rate of 95 l/min for both the solid particles (0.65 μm NaCl) and the paraffin oil challenge, with a minimum filtering area is 185 cm² for inhalation and 200 cm² for exhalation.

Some of the objects of the invention having been stated hereinabove, and which are addressed in whole or in part by the present invention, other objects will become evident as the description proceeds when taken in connection with the accompanying drawings as best described hereinbelow.

### BRIEF DESCRIPTION OF THE DRAWINGS

FIG. 1 is a schematic of a two-ply fabric of this invention which comprises a barrier layer such as a melt blown (MB) microfiber nonwoven or a breathable microporous or monolithic film and the second layer may be any woven, knitted, open mesh film or nonwoven fabric, which may not be bonded or may be bonded by mechanic, thermal or adhesive means and may be bonded in a variety of patterns;

FIG. 1a is a computer scan from the film side of a monolithic breathable film coated to the spunbond (SB) polypropylene (PP) side of a composite nonwoven of this invention, consisting of a carded web of a blend of cotton and PP staple fiber bonded to a SB PP nonowoven;

FIG. 1b is a computer scan of the cotton side of the sample in FIG. 1a.

FIG. 2 is a schematic of a multiple-ply fabric of this invention which comprises a top (outside) fabric which may be any woven, knitted, open mesh film or nonwoven and the middle layer comprises a barrier fabric such as a MB nonwoven or a breathable microporous or monolithic film and the bottom (inside) layer comprises another woven, knitted, open mesh film or nonwoven, which may not be bonded or which may be bonded by mechanic, thermal or adhesive means and may be bonded in a variety of patterns;

FIG. 2a is a computer scan of a thermally pattern-calendered laminate of this invention consisting of a top layer of a blue colored SB PP with a microporous (MP) PP film in the middle layer and a nonwoven composite of a carded cotton/staple fiber blended web bonded to a SB PP on the bottom side, and on the outer blue SB side a monolithic breathable film has also been applied;

FIG. 2b is a computer scan of the cotton bottom-side of the sample in FIG. 2a in which the blue SB top side was shown;

FIG. 3 and FIG. 3a are computer scans showing the outer surface of an un-bonded protective surgical face mask of this invention (bonded only at the seams) with an blue SB PP fabric and a middle layer of MB PP nonwoven and a inside (face-side) consisting of a 100% cotton hydroentangled (spunlaced) nonwoven;

FIG. 3b is a computer scan of the face mask in FIGS. 3 and 3a from the cotton hydroentangled side;

FIGS. 4, 4a and 4b are photographs of an example of a three-ply thermal pattern-calendered respirator produced commercially by photographed from different views;

FIG. 5 is a photograph of a commercial multi-ply medical protective gown (in which the protective garment fabric of this invention may be utilized) being worn of a technician;

FIG. 6 is a photograph of an un-bonded three-ply surgical face mask of this invention, which is only bonded at the seams, of the invention being worn by a technician;

FIGS. 7 and 7a are front and side views of a thermally pattern-calendered respirator (respirator sample provided by Bacou-Dalloz France, in which laminate of this invention may be utilized) being worn by a technician;

FIG. 8 is a planar view of a process for preparation of thermally point-bonded (pattern-calendered) Cotton-Surfaced Nonwovens (CSNs) of this invention on the spunbond (SB) line by introducing a carded cotton/polypropylene web on one or both sides of the spunbond web prior to the SB thermal calender;

FIG. 9 is a planar view of a process for preparation of thermally point-bonded (pattern-calendered) protective garment fabric of this invention on the spunbond (SB) line by introducing a thermally fusible breathable film after lay-down of the un-bonded SB filament web, followed by the overlaying on the breathable film by a cotton-surfaced nonwoven (CSN) or a hydroentangled nonwoven of cotton (HEC) blended with a thermally fusible synthetic fiber (SF), hereinafter referred to as HEC/SF, and the ensemble is then thermally pattern-calendered on the SB line before wind-up or further in-line finishing;

FIG. 9a is a planar view of a process for preparation of thermally point-bonded (pattern-calendered) face mask or respirator laminate of this invention on the SB line by introducing a melt blown (MB) microfiber or an electrospun (ES) nanofiber web or a combination thereof after lay-down of the un-bonded SB filament web, followed by the overlaying of the microfiber and or nanofiber web by a cotton-surfaced nonwoven (CSN) or a HEC/SF and the ensemble is then thermally pattern-calendered on the SB line before wind-up or further in-line finishing;

FIG. 9b is a planar view of a process for preparation of a protective garment fabric of this invention on the SB line by thermal-point bonding the SB web prior to the application of aqueous or solvent-based breathable monolithic film, followed by overlaying of the film coating with a CSN or HEC or HEC/SF followed by drying and curing of the film coating in a hot air oven, infrared heaters, ultraviolet heaters, radio wave or ultrasonic heaters, by heated contact rollers or by any combination thereof, before wind-up or further in-line finishing;

FIG. 9c is a planar view of a process for preparation of a protective garment fabric of this invention on the SB line in which a SB, HEC or HECwSF nonwoven may be produced in-line or off-line and unwound from an unwind device and onto the nonwoven, an aqueous or solvent-based breathable monolithic film may be applied followed by the overlaying of a CSN, HEC or HEC/SF, followed by drying and curing of the film coating in a hot air oven, infrared heaters, ultraviolet heaters, radio wave or ultrasonic heaters, by heated contact rollers or by any combination thereof, before wind-up or further in-line finishing;

FIG. 9d is a planar view of a process for preparation of un-bonded face mask laminate of this invention in which the SB nonwoven may be made in-line or off-line and unwound onto a conveyor belt by the overlaying of a MB or ES web or a combination thereof, which is in-turn overlaid by a CSN or HEC or HEC/SF.

FIG. 10 is a planar schematic illustration of the lamination of a multi-ply protective garment laminate of this invention consisting of a bottom layer of SB web, second layer of a breathable film, a third layer of a carded fibers produced in-line with a top layer of SB or HEC or HEC/SF web followed by windup without bonding, and then in a separate process as illustrated in FIG. 10 or in-line as a part of the same process, the un-bonded laminate is thermally bonded by a diamond patterned calendar roller over a smooth roller, followed by contact with chill rollers before wind-up or further in-line finishing;

FIG. 11 is a planar view of the preparation of ultrasonically bonded face mask, respirator or protective garment laminate of this invention produced by unwinding a roll of un-bonded face mask, respirator or protective garment laminate followed by ultrasonic bonding of the laminate and wind-up or further in-line finishing;

FIG. 12 is a three-dimensional (3-D) sketch depicting the application of a protective finish to one side of the fabric by spraying and the same or a different protective finish or combination of protective finishes may be similarly applied to the other side of the fabric and the finishes on each side may be dried and cured in separate in-line ovens or in the same oven after the finishes have been applied to both sides;

FIG. 13 is a 3-D sketch depicting the application of a protective finish to one side of the fabric by foam application and the same or a different protective finish or combination of protective finishes may be similarly applied to the other side of the fabric following by drying and curing of the fabric and the finishes on each side may be dried and cured in separate in-line ovens or in the same oven after the finishes have been applied to both sides;

FIG. 14 is a 3-D sketch depicting the application of a protective finish to one side of the fabric by knife-over-roll coating and the same or a different protective finish or combination of protective finishes may be similarly applied to the other side of the fabric followed by drying and curing of the finish and the finishes on each side may be dried and cured in separate in-line ovens or in the same oven after the finishes have been applied to both sides;

FIG. 15 is a 3-D sketch depicting the saturation application of the same protective finish to both sides of the fabrics followed by drying and curing of the finish in an oven;

FIG. 16 is a sketch of the Tantret™ Electrostatic Charging System depicting two stations for Technique I charging (corona wire-over-biased roller) and two stations for Technique II charging (corona wire-in-biased shell) for electrostatic charging of fibrous webs, which may be performed on the filter media before lamination to other substrates and before finishing or after lamination and finishing, depending on the filter media weight and fabric ensemble composition;

FIG. 17 is a plot showing the penetration of DOP with loading time of electrostatically charged melt blown (MB) PP with the inventive and effective fluorochemical (FC) treatment (W/FC T1), compared to two MB PP webs without FC treatment, but charged by two different methods;

FIG. 18 is a plot of the penetration of DOP with loading time of a high efficiency filter media (P100) as it is degraded by DOP loading;

FIG. 19 shows the effect of charge degradation (increased DOP penetration) with DOP loading time on two plies of 30 gsm MB PP fabrics with with and without FC treatment;

FIG. 20 shows the charge degradation by DOP on four plies of 30 gsm MB PP fabrics with and without FC treatment;

FIG. 21 shows the effects of DOP loading time on three types of uncharged fabrics;

FIG. 22 shows the decrease of penetration with loading time of NaCl on a N95 respirator.

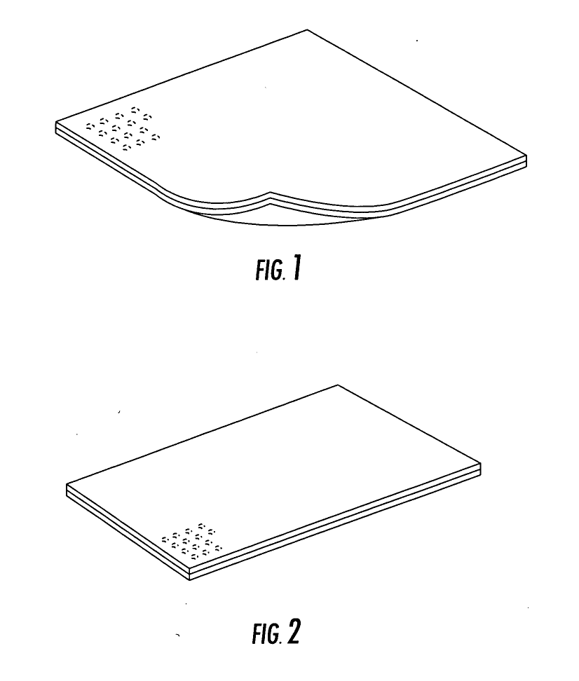

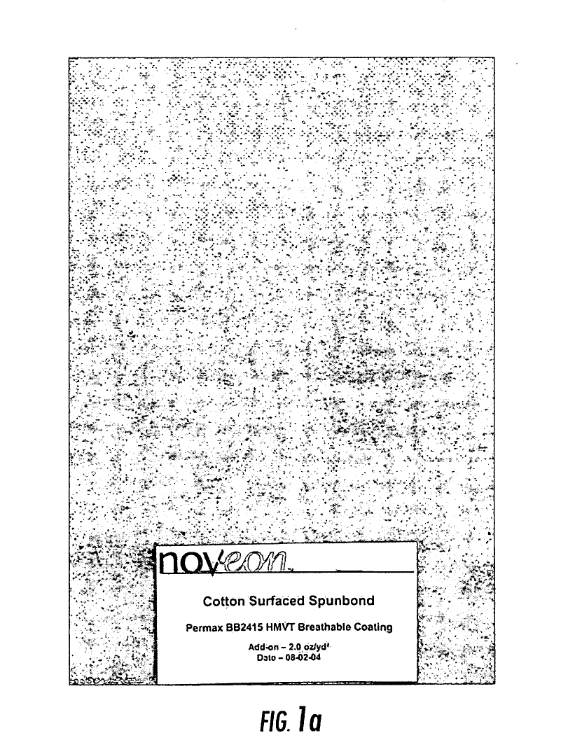

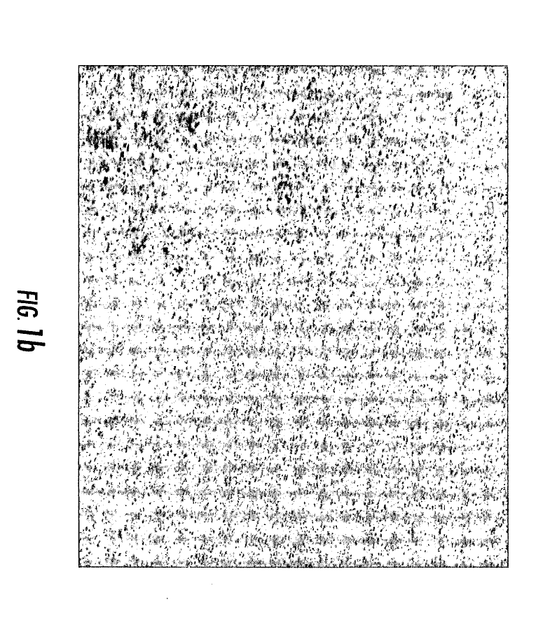

### DETAILED DESCRIPTION OF THE INVENTION

### Novel Methods for Making Electret Media and Remediation of Charge Degradation

Fibrous materials are widely used as filter media due to the large surface area of the fibers that provide high filtration efficiency (FE) and low pressure drop. The materials if properly chosen can be effectively electrostatically charged and the FE is greatly improved without the increase of the pressure drop (Tsai, P. and Wadsworth, L, “Air Filtration Efficiency Improved by Electrostatic Charging of Meltblown Webs,” Proc. American Filtration Society Conference, Apr. 24-26, Nashville, 1995. ). There are numerous methods to charge the media including triboelectrification (Brown, R., “Blended-fibre Filter Material,” U.S. Pat. No. 4,798,850, Jan. 17, 198; Wnenchak, R., “Triboelectric Filtration Material,” U.S. Pat. No. 5,368,734, Dec. 20, 1993; Auger, R., “Triboelectric Air Filter,” U.S. Pat. No. 6,328,788, Dec. 11, 2001), corona charging and electret modifications (Turnhout, J., “Method for the Manufacture of an Electret Fibrous Filter,” U.S. Pat. No. 3,998,916, Dec. 21, 1976; Felton, C., et al, “Electret Making Process Using Corona Discharge,” U.S. Pat. No. 4,623,438, Nov. 18, 1986; Jones, M. and Rousseau, A., “Oil Mist Resistant Electret Filter Media and Method for Filtering,” U.S. Pat. No. 5,411,576, May 2, 1995; Lifshutz, N., et al, “Charge Stabilized Electret Filter Media,” U.S. Pat. No. 5,645,627, Jul. 8, 1997), electrostatic spinning (Formhals, A., “Process and Apparatus for Preparing Artificial Threads,” U.S. Pat. No. 1,975,504, 1934; Tsai, P. and Schreuder-Gibson, H., “Different Electrostatic Methods for Making Electret Filters,” Journal of Electrostatics, 54(2000), PP 335-341; Tsai, P. and Schreuder-Gibson, H., “The Role of Fiber Charging on Co-electrospinning and the Resident Life of the Residual Charges from the Electrospinning Process,”16th AFS Annual Technical Conference, The Nugget Hotel and Resort, Reno, Nev., Jun. 17-20, 2003], and hydrocharging (Angadjivand, S. and Jones, M., “Method of Charging Electret Filter Media,” U.S. Pat. No. 5,496,507, Aug. 17, 1994), etc., just to name a few. Different charging methods provide different chargeability and different retention abilities of the charges in the fibers. However, the charges will decay during shelf time or even worse at elevated temperatures (Tsai, P. and Huang, H., “Theoretical and Experimental Studies on the Charge Decay of Corona-charged Fibrous Electrets,” Fluid/Particle Separation Journal, Vol. 14, No.2, 2002, PP 89-94). The charges will also deteriorate with the particle loading (Raynor, P. and Chae, S., “Dust Loading on Electrostatically Charged Filters in a Standard Test and Real HVAC System,” Filtration+Separation, March 2003, pp 35-39; Wadsworth, L. and Tsai, P., “Development and Characterization of Innovative Electrostatically Charged Depth Filter Composites,” Fluid/Particle Separation Journal, Vol. 12, No.1, Apr. 1999) and even at a faster rate with oily particles (Tsai, P. and Wadsworth, L., “Effect of Polymers and Additives on the Electrostatic Charging of Different Meltblown Web Structures,” Proc. 5th TANDEC Conference, UT Convention Center, The University of Tennessee, Oct. 31-Nov. 2, 1995). The charge decay by oily particle loading, by shelf time or by elevated temperatures improved by additives and by chemical treatment will be discussed in this invention. A novel method to remedy the charge decay problems by heat and by particle loading will also be presented as well.

Experimental

MB fabrics, PP, PU and nylon, were prepared in this study. The fiber diameters were 2 μm, 20 μm and 6 μm for PP, PU and nylon, respectively, from SEM measurements. The N95 and P100 respirators were obtained from Lab Safety Supply. MB PP was treated with novel fluorochemicals to inhibit the charge degradation by DOP loading. Novel additives as charge stabilizer were blended with the PP polymer resins to improve the charge retention life of the electrets during shelf time or at elevated temperatures.

A TSI Model 8130 filter tester was used to measure both the NaCl and DOP loading efficiencies of the filter media and the respirators. The NaCl particles had a number average particle size of 0.067 μm and geometric standard deviation (GSD) of 1.6, and the DOP particles with number average particle size of 0.2 μm and the same GSD as DOP. The aerosol concentrations were 100 mg/m³ and the filtration flow rate was 32 lpm for NaCl aerosol, 55 lpm for DOP aerosol, and 85 lpm for respirators using DOP aerosol. The filtration area for the flat sheet media was 100 cm².

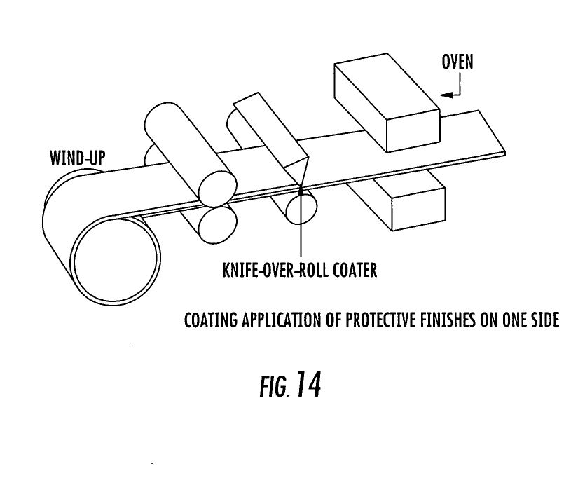

The TANTRET charging techniques, as depicted in FIG. 16, developed at the University of Tennessee (Tsai, P. and Wadsworth, L., “Method and Apparatus for the Electrostatic Charging of a Web or Film,” U.S. Pat. No. 5,401,446, Mar. 28, 1995) were employed to perform the charging of the MB PP fabrics. The MB PP fabrics were also tested for the charge decay during shelf time at ambient temperature about 25 C and at elevated temperatures of 45 C, 70 C, 80 C and 90 C for different periods of time, 24 hours and 30 to 50 days.

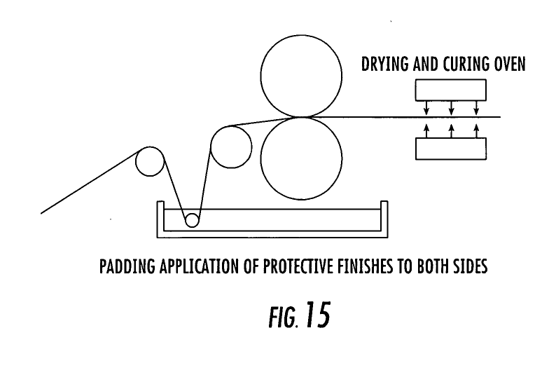

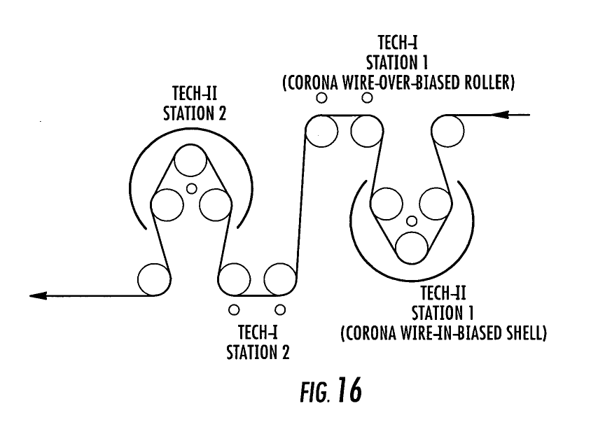

Results and Discussions The FE of the charged meltblown (MB) PP fabrics was degraded by DOP loading, as indicated by the curve W/O FC T1 in FIG. 17, as in which the media was not treated with a fluorochemical (FC). The charged PP had a steady DOP resistance if the media was properly treated with FC as shown by the curve W/FC T1 in the same FIG. 17. The media also had a steady DOP resistance as well shown by the curve W/O FC T2 without the FC-treatment but charged using different charging technique. As illustrated in FIG. 18, for a commercial P100 respirator, which is believed that was treated with FC, the media resisted the DOP degradation for a lengthy time but the penetration was increased at a rapid rate once the charges in the media were saturated by the DOP particles, which occurred at around 45 minute loading.

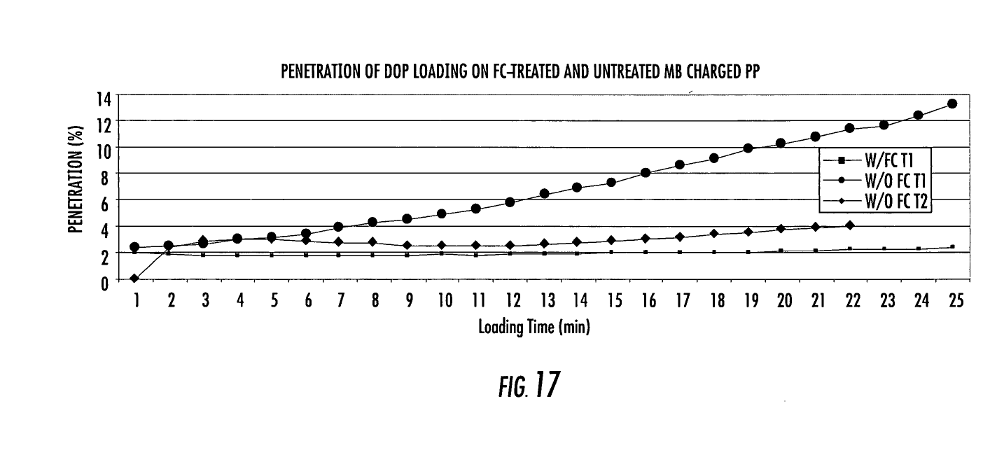

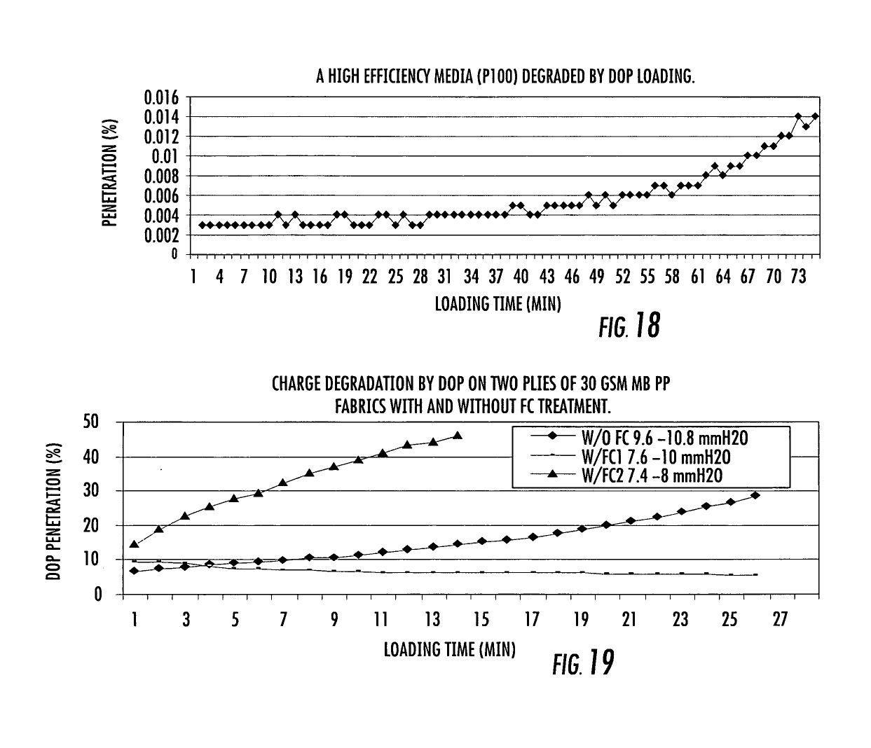

As illustrated in FIG. 19, the FE by DOP loading on the two plies of each 30 gsm MB PP was stabilized by the FC treatment labeled as W/FC1 as compared with the one without the FC treatment labeled as W/O FC. However, the DOP was degraded at a faster rate if the FC was not properly selected or treated as shown by the curve W/FC2 in FIG. 19. Two plies of the same material have more mass than one ply. Therefore, they had better resistance to degradation and slower decay rate by DOP loading than the one ply in FIG. 17. The same trend is true for the four plies of the each 30 gsm fabrics as shown in FIG. 20.

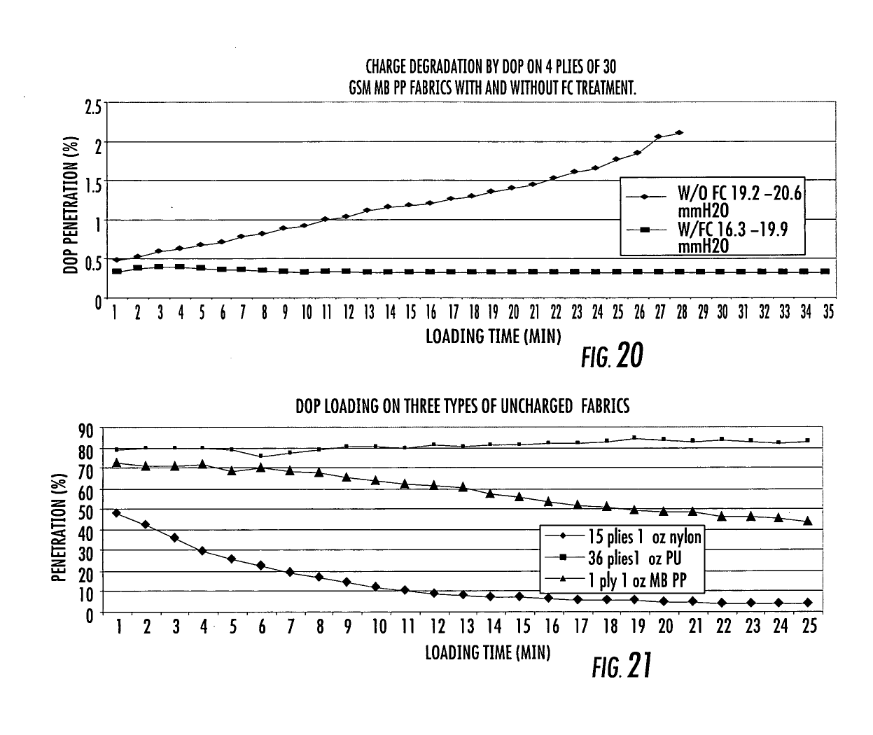

As shown in FIG. 21, the FE was increased by DOP loading on uncharged PP and nylon media while the FE was not much affected by DOP loading on glass and PU media. It was probably because of the coalescing of DOP particles on the fiber surface on nylon and PP then the coated DOP served as tackifier to stick the incoming particles. In the PU and glass fiber media, the DOP particles were probably attached on the fiber surface as particle form so they were not functioned as tackifier.

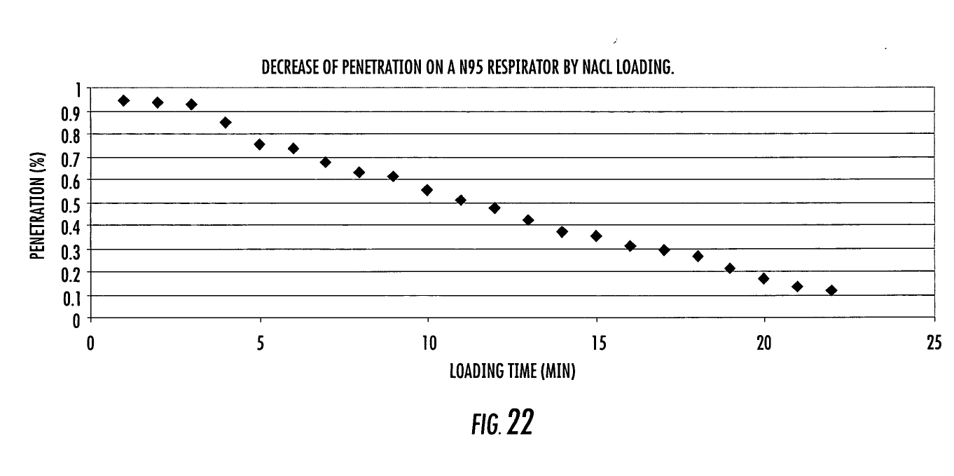

FIG. 22 shows the increase of the FE by the loading of NaCl particles on a N95 respirator. The particles formed a cake on the MB electret surface and the cake served as a layer of filter media. This phenomenon agreed with the observation in our previous research (Wadsworth, L. and Tsai, P., “Development and Characterization of Innovative Electrostatically Charged Depth Filter Composites,” Fluid/Particle Separation Journal, Vol. 12, No. 1, April 1999).

The charge decay rate of the MB PP fabrics with the charge additive was much slower than the one without the additive for both shelf time at ambient temperature and at elevated temperatures for different periods of time as illustrated in Table 2.

Conclusions

The charges in the electrostatically charged PP electrets dissipated with time at ambient conditions and by particle loading as well. The charges dissipated at a much faster rate under elevated temperatures or by the loading of oily type particles. The FE was increased by oily particle loading for some uncharged media, e.g., PP and nylon, while it stayed steady for some other uncharged media, e.g., PU and glass fibers. The charge degradation by heat was inhibited by selective charge additive and the degradation by oily particle loading was remedied by proper FC treatment.

TABLE 2
Filtration efficiencies of MB PP before and after charge decay

| | Control (W/O Charge Additive) | | With Charge Additive | |
|---|---|---|---|---|
| Decay | | P. Drop | | P. Drop |
| Conditions | FE(%) | (mmH2O) | FE(%) | (mmH2O) |
| Initial | 95.1 | 2.2 | 97.8 | 2.1 |
| 70 C., | 93.2 | 2.1 | 96.1 | 2 |
| 24 hrs. | | | | |
| 80 C., | 92.5 | 2.4 | 96.2 | 2.2 |
| 24 hrs. | | | | |
| 90 C., | 91.7 | 2.4 | 95.2 | 2.1 |
| 24 hrs. | | | | |
| 45 C., | 91.9 | 2.3 | 96.6 | 2.1 |
| 30 days | | | | |
| Ambient, | 93.2 | 2.8 | 97.2 | 2.6 |
| 50 days | | | | |
| Ambient, | 84.6 | 2.8 | 92.3 | 2.4 |
| 50 days* | | | | |

*DOP

The invention not only requires the application of a FC to the MB PP, but the thermal and chemical properties of the relatively few fluorochemicals that will work also requires a highly specialized knowledge of the physics of electrostatic charging and much technical skill and experience in the practice of electrostatic charging taking into account the complexities of interactions among the corona charges generated and the chemical and electric properties of the fibers and chemicals required. In summary, the PP fibers in the MB filter media have higher surface energy than the oily materials such as the aerosols of DOP, which are able to spread on the surface or penetrate into PP fibers. The fluorochemicals (FC) have lower surface energy than the oily mists. When the PP fibers are coated by the FC, the FC will prevent the oil from spreading out on the fiber surface or penetrating into the fibers. Usually the fluorochemicals for nylon, polyester or for cellulose fibers are the type of high curing temperatures at 175 C or higher. The fluorochemicals need to be of the low temperature curing for PP, e.g. <150 C, preferably <130 C. The emulsifier for the FC needs to be weakly cationic so the corona charges generated during electrostatic charging will not be bled off by the inherent charges in the emulsifier. Examples that fall into this category are Repearl 45 and Repearl 8095 from Mitsubishi International Corporation.

### PREPARATION AND FINISHING OF EXAMPLE FACE MASK AND PROTECTIVE GARMENT FABRICS

### EXPERIMENTAL

### Repellent/Antimicrobial/Latex and Combination Treatments of Face Mask Components and Protective Breathable Barrier Fabrics for Protection Against Air- and Liquid-Borne Pathogens

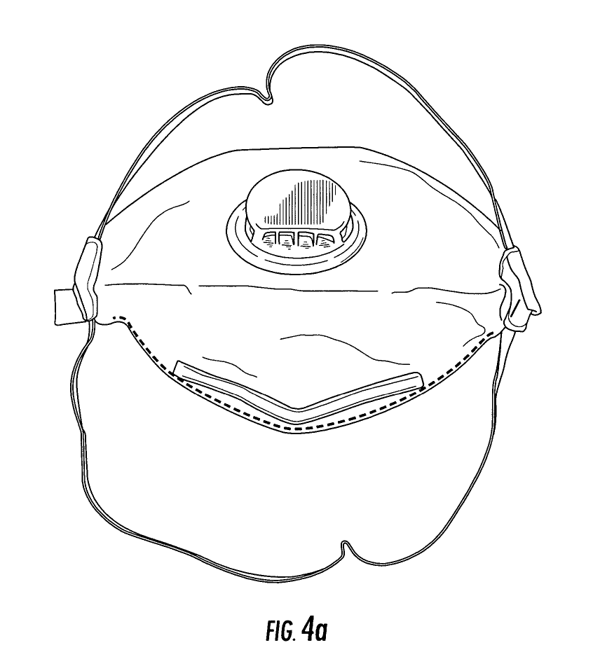

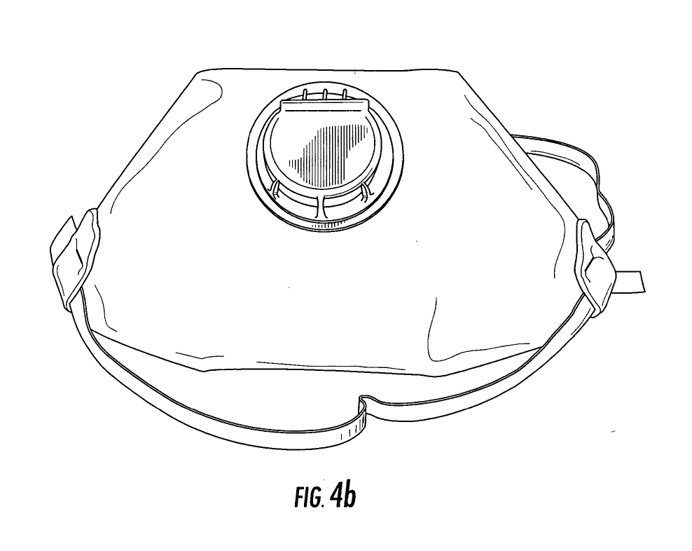

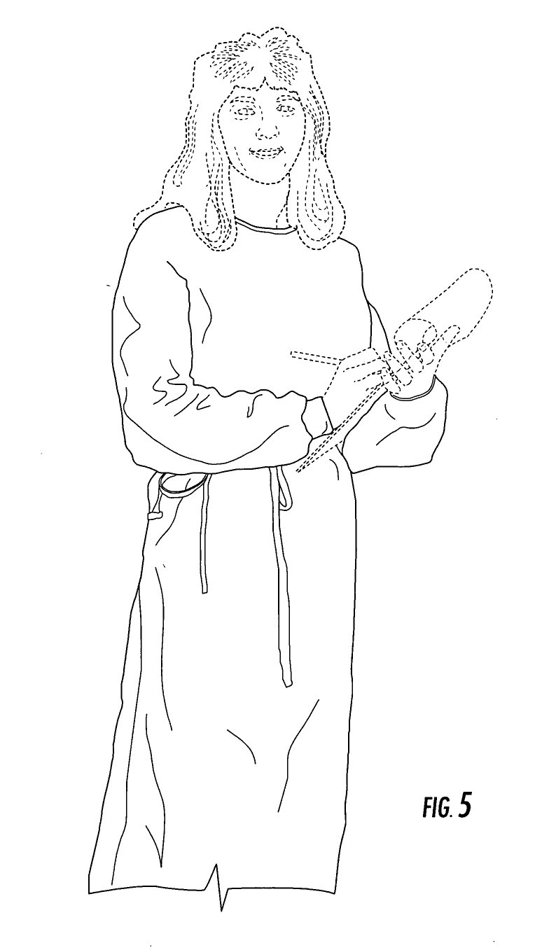

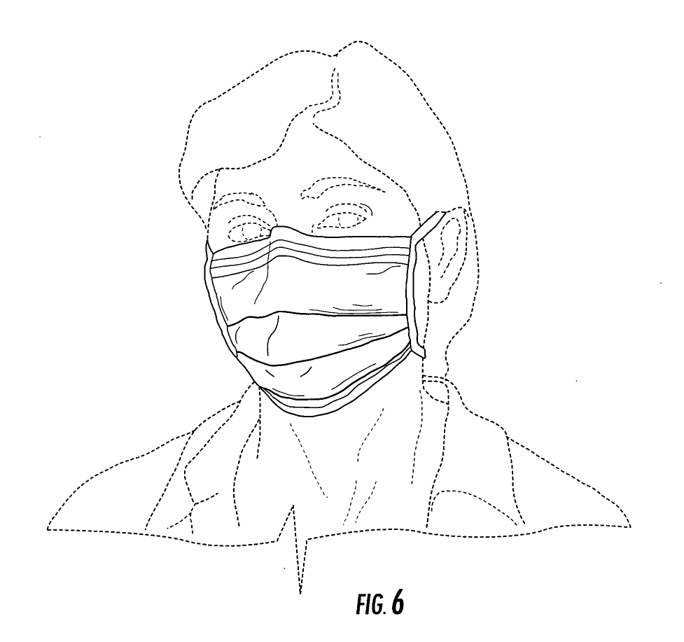

Face masks with exceptionally high filtration efficiency against 0.1 micrometer (pm) NaCl particles and with good breathability have been invented by these inventors at the University of Tennessee using state-of-the-art melt blown, spunbond, laminating, and Tantret™ electrostatic charging (also invented by these inventors) equipment at the Textiles and Nonwovens Development Center (TANDEC). The current invention also includes protective clothing fabrics as illustrated in FIG. 5, with breathable films and antimicrobial treatments. To determine the effectiveness of additional enhancements such as repellent finishing, antimicrobial treatment, latex reinforcement of Cotton-Surfaced Nonwovens (CSNs) and combinations of these treatments to the different components of face masks and breathable protective clothing, formulations and application techniques have been developed as described in the categories I, II, III and IV in the following section on “Finishing of Laminate Components.”

The face mask components and un-bonded laminates developed at TANDEC ranged in width from 12 to 20 inches. To determine the relative effectiveness of each component/treatment of the face mask laminates that contribute to protection from HIV, SARS and other viral and bacterial pathogens, the following combinations were evaluated. Since the face masks were not bonded together, the inner and outer facings were removed and treated separately. It should be noted that the special antimicrobial finishes were applied to these fabrics, SiS 200 SARS (SiShield Technologies File No. 221) was only recently developed by SiShield Technologies Inc., 5555 Glenridge Connector, Suite 200, Atlanta, GA 303342. SiS 200 SARS is based on their very successful SIS 500 TEX, an antimicrobial organsilane quarternary amine, which has been effectively applied for a number of years to conventional textiles and to nonwovens to inhibit growth of odor causing bacteria, prevent growth of mold and mildew and for dust mite control. Furthermore this product has been proven to be durable to at least 50 launderings, even without the addition of latex binders to possibly further enhance its retention by the fabric. This is an excellent feature for nonwovens even if they are used only one time or a limited number of times and disposed since the AM finish should not migrate from the fabric and cause skin irritation or respiratory irritation when one breaths through the AM treated filter fabric. Both SIS 500 TEX and SiS 200 SARS are approved by the U.S. Environmental Protection Agency. SiS 200 SARS was approved by the U.S. EPA to combat SARS. According to its MDS dated Jan. 2, 2003, the ingredients include 3-(Trimethoxysilyl)propyldi, methyloctadecyl ammonium chloride, and four other proprietary ingredients.

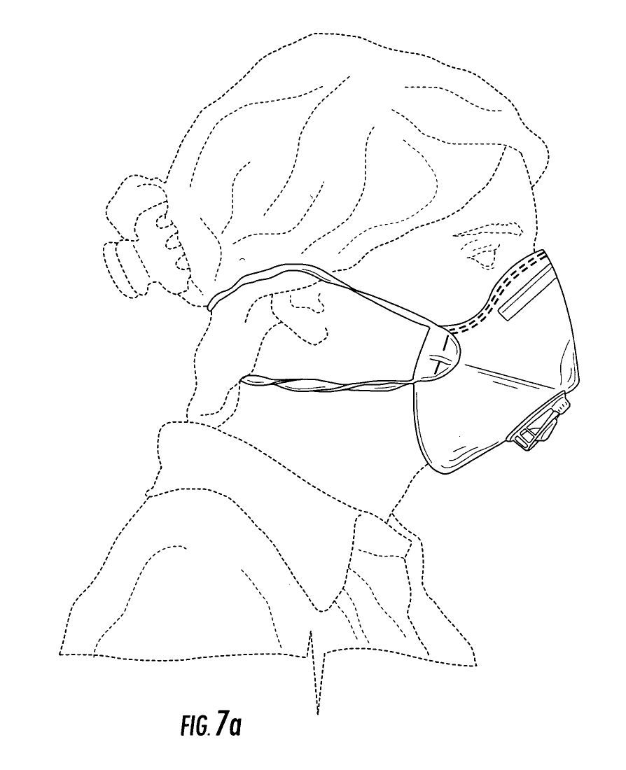

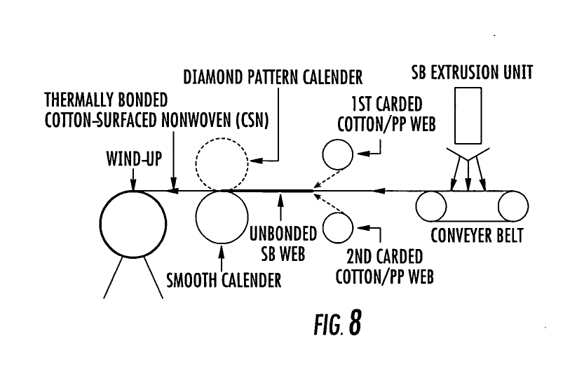

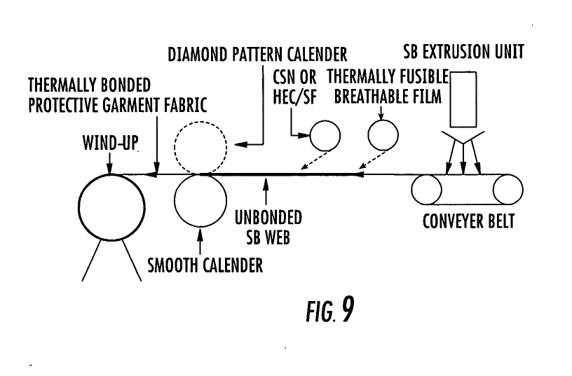

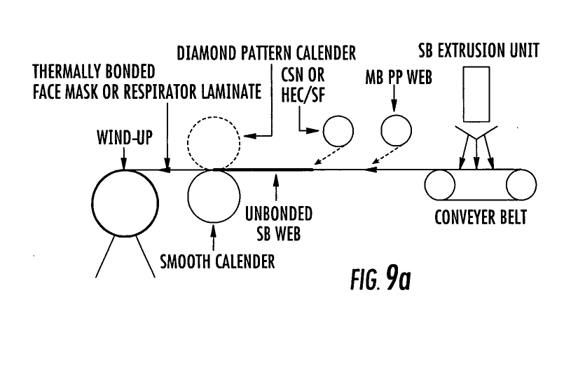

Formulations and procedures for both padding and spraying applications were developed for treating the different components of face mask since they could be separated and put back together after the different finishing treatments as described below.
1) Face mask laminates prepared as illustrated in FIG. 9d with outer colored 25 gsm spunbond (SB) PP and face-side 17 gsm SB PP, without a cotton surface, treated only with FC finish. The center 17.25 gsm melt blown (MB) PP filter media was not electrostatically charged.
2) Same as 1 above, except center 17.25 gsm MB PP was electrostatically charged by Tantret™ Technology as illustrated in FIG. 16.
3) Face mask laminates with outer colored 25 gsm spunbond (SB) PP and face-side 17 gsm SB PP, without a cotton\surface, treated only with SiS SARS 200 Antimicrobial (AM) finish, which is the only AM approved by the U.S. Environmental Protection Agency (EPA) for killing the SARS virus, and the center 17.25 gsm melt blown (MB) PP filter media was not electrostatically charged.
4) Face mask laminates with outer colored 25 gsm spunbond (SB) PP and face-side 17 gsm SB PP treated only with SiS SARS 200 Antimicrobial (AM) finish and the center 17.25 gsm melt blown (MB) PP filter media electrostatically charged by Tantret™ technology as illustrated in FIG. 16.
5) Face mask laminates with outer colored 25 gsm spunbond (SB) PP and face-side 17 gsm SB PP treated with a combination of FC and SiS SARS 200 Antimicrobial AM finish and the center 17.25 gsm melt blown (MB) PP filter media was not electrostatically charged.
6) Face mask laminates with outer colored 25 gsm spunbond (SB) PP and face-side 17 gsm SB PP treated with a combination of FC and SiS SARS 200 Antimicrobial (AM) finish and the center 17.25 gsm melt blown (MB) PP filter media was electrostatically charged by Tantret™ technology as illustrated in FIG. 16.

The 1.0 meter wide breathable protective thermally bonded laminates constructed at TANDEC as illustrated in FIG. 9 were trimmed to a width of 20 inches. To determine the relative effectiveness of each treatment of the breathable barrier fabrics that contribute to protection from viral and bacterial penetration, the following combinations were evaluated. Since the breathable protective fabrics developed at TANDEC were thermally bonded and could not be delaminated and finished separately (after bonding in this case) a topical spraying application was the preferred way to apply the different finishes. The different protective finish treatments applied to the garment fabrics were as follows:
1) Thermally bonded breathable protective laminate with outer colored 25 gsm spunbond (SB) PP and face-side CSN on 17 gsm white SB PP only with FC finish. The center layer had a PP microporous film (MP) [the laminate with MP PP has been shown to have an MVTR of 3600 g/m²/24 hr and can further improved].
2) Same as 1 above, except center layer was a PE MP [the laminate with MP PE has been shown to have a MVTR of 7805 g/m²/24 hr] and was much softer than the above laminate with a center layer of the same weight PP MP film.
3) Breathable protective laminate with outer colored 25 gsm spunbond (SB) PP and face-side CSN on 17 gsm SB PP treated only with SiS SARS 200 Antimicrobial (AM) finish.
4) Breathable protective laminate with outer colored 25 gsm spunbond (SB) PP treated with a FC and SiS SARS 200 finish and body-side CSN on 17 gsm SB PP treated with the combination of FC and SiS SARS 200 AM finish.
5) Breathable protective laminate with outer colored 25 gsm spunbond (SB) PP treated with a FC only and with the CSN on the body side treated with a combination of latex binder (Noveon Hystretch V-29) to prevent Tinting of the cotton and to better tie down the AM finish and SiS SARS 200 finish.
   Finishing of Laminates and Component Fabrics

I. Repellent Finishing Only of SB PP Inner and Outer Fabrics

A. Pad-Dry-Cure Application of DuPont Zonyl 70-40 Fluorochemical (FC)

Pad Bath Composition (for a 100% Wet Pickup of bath by fabric and total bath weight of 10,000 g)

| | Composition | Amount | |
|---|---|---|---|
| Ingredient | (Wt % of Bath) | (G/10,000 G) | |
| 1) Distilled Water | 95.75% | 9,575 | g |
| 2) 1-Octanol | 0.25% | 25 | g |
| (Disperse in water at high speed to prevent “oiling out” | | | |
| 3) Dupont Zonyl 7040 | 4.0% (as-received) | 400 | g |
| | Total Bath Weight | 10,000 | g |

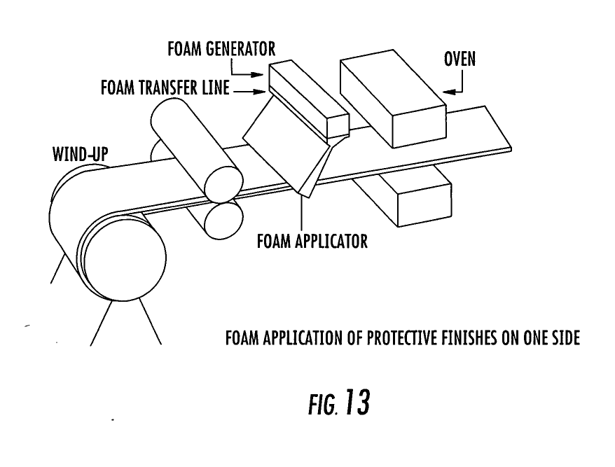

Procedures (illustrated in FIG. 15):

Padding

Sew re-usable leader fabrics to both ends of a 1.0 m length of pre-weighed SB fabric and weight after the dip and squeeze thru padder to determine % WPU. Repeat procedure and adjust padder nip pressure to obtain a 100% WPU.

Dry-Cure

For fabrics not containing MP PE, set the oven or drying/curing zone at a temperature of 121° dry/cure in a tenter oven for three minutes. For fabrics containing MP PE, the oven temperature was to be set at 108° C.

B. Spray-Dry-Cure Application of DuPont Zonyl 70-40 FC

Spray Bath for a 50% WPU (for a 50% WPU and total bath weight of 5000 g)

| | Composition | Amount | |
|---|---|---|---|
| Ingredient | (Wt % of Bath) | (G/10,000 G) | |
| 1) Distilled Water | 91.5% | 4,575 | g |
| 2) 1-Octanol | 0.5% | 25 | g |
| (Disperse in water at high speed to prevent “oiling out” | | | |
| 3) Dupont Zonyl 7040 | 8.0% (as-received) | 400 | g |
| | Total Bath Weight | 5,000 | g |

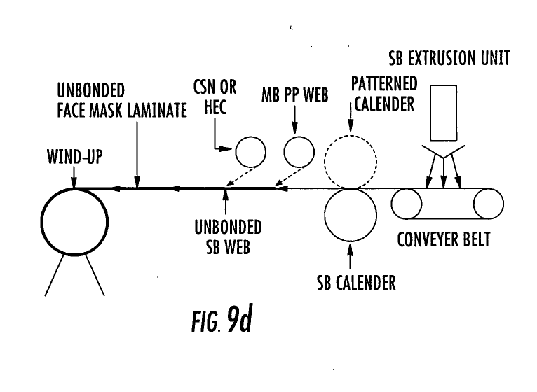

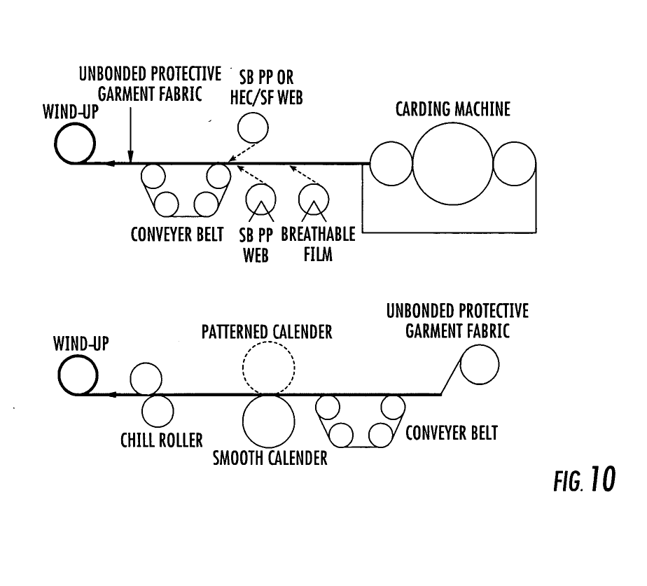

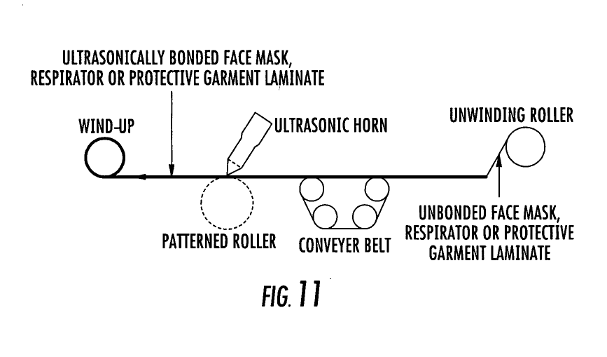

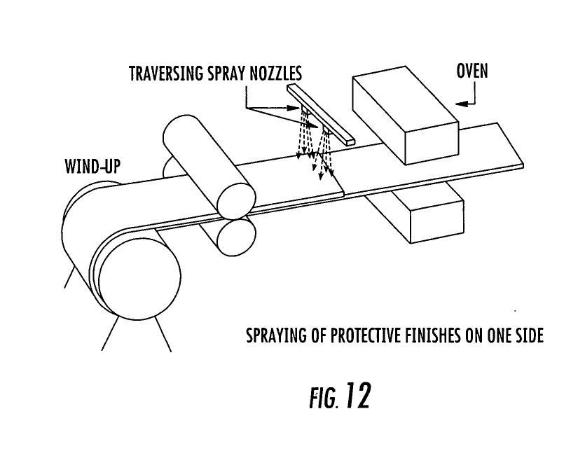

Procedure (illustrated in FIG. 12, except a heated drum roller was in tandem after the oven):

Dry-Cure

For fabrics not containing MP PE, the tunnel oven temperature and the heated contact drum rollers were set at a temperature of 121° C. with an exposure time in the oven of 90 seconds and 70 seconds on the heated drum rollers. For fabrics containing PE, the oven and drum temperatures were set at 108° C.

II Antimicrobial (AM) Finishing if Laminates or Component Fabrics

A. Pad-Dry-Cure Application of SiS 200 SARS AM

Pad Bath Composition (for a 100% Wet Pickup of bath by fabric and total bath weight of 10,000 g)

| | Composition | Amount | |
|---|---|---|---|
| Ingredient | (Wt % of Bath) | (G/10,000 G) | |
| 1) Distilled Water | 95.75% | 9,575 | g |
| 2) 1-Octanol | 0.25% | 25 | g |
| (Disperse in water at high speed to prevent “oiling out” | | | |
| 3) SiS SARS 200 | 4.0% (as-received) | 400 | g |
| | Total Bath Weight | 10,000 | g |

Procedures (illustrated in FIG. 15):

Padding

Sew re-usable leader fabrics to both ends of a 1.0 m length of pre-weighed SB fabric and weight after the dip and squeeze thru padder to determine % WPU. Repeat procedure and adjust padder nip pressure to obtain a 100% WPU.

Dry-Cure

For fabrics not containing MP PE, set the oven or drying/curing zone at temperature of 121° dry/cure in a tenter oven for three minutes. For fabrics containing MP PE, the oven temperature was to be set at 108° C.

B. Spray-Dry-Cure Application of DuPont Zonyl 70-40 FC

Spray Bath for a 50% WPU (for a 50% WPU and total bath weight of 5000 grams)

| | Composition | Amount | |
|---|---|---|---|
| Ingredient | (Wt % of Bath) | (G/10,000 G) | |
| 1) Distilled Water | 91.5% | 4,575 | g |
| 2) 1-Octanol | 0.5% | 25 | g |
| (Disperse in water at high speed to prevent “oiling out” | | | |
| 3) SiS 200 SARS | 8.0% (as-received) | 400 | g |
| | Total Bath Weight | 5,000 | g |

Procedure (illustrated in FIG. 12 except a heated drum roller was in tandem after the oven):

Dry-Cure

For fabrics not containing MP PE, the tunnel oven temperature and the heated contact drum rollers were set at a temperature of 121° C. with an exposure time in the oven of 90 seconds and 70 seconds on the heated drum rollers. For fabrics containing PE, the oven and drum temperatures were set at 108° C.

III. Combined FC/SiS 200 SARS Antimicrobial (AM) Finishes

A. Pad-Dry-Cure Application of DuPont Zonyl 70-40 Fluorochemical (FC) and SiS 200 SARS AM

Pad Bath Composition (for a 100% Wet Pickup of bath by fabric and total bath weight of 10,000 g)

| | Composition | Amount | |
|---|---|---|---|
| Ingredient | (Wt % of Bath) | (G/10,000 G) | |
| 1) Distilled Water | 89.75% | 8,975 | g |
| 2) 1-Octanol | 0.25% | 25 | g |
| (Disperse in water at high speed to prevent “oiling out” | | | |
| 3) Dupont Zonyl 7040 | 4.0% (as-received) | 400 | g |
| _ (Add Z 7040 and then SiS SARS & mix both with gentle agitation) | | | |
| 4) SiS 200 SARS | 6.0% (as-received) | 600 | g |
| | Total Bath Weight | 10,000 | g |

Procedures (illustrated in FIG. 15):

Padding

Sew re-usable leader fabrics to both ends of a 1.0 m length of pre-weighed SB fabric and weight after the dip and squeeze thru padder to determine % WPU. Repeat procedure and adjust padder nip pressure to obtain a 100% WPU.

Dry-Cure

For fabrics not containing MP PE, set the oven or drying/curing zone at temperature of 121° dry/cure in a tenter oven for three minutes. For fabrics containing MP PE, the oven temperature was to be set at 108° C.

B. Spray-Dry-Cure Application of Zonyl 70-40 Fluorochemical (FC) and SiS 200 SARS AM

Spray Bath for a 50% WPU (for a 50% WPU and total bath weight of 5000 grams)

| | Composition | Amount | |
|---|---|---|---|
| Ingredient | (Wt % of Bath) | (G/5,000 G) | |
| 1) Distilled Water | 79.5% | 4,575 | g |
| 2) 1-Octanol | 0.5% | 25 | g |
| (Disperse in water at high speed to prevent “oiling out” | | | |
| 3) Dupont Zonyl 7040 | 8.0% (as-received) | 400 | g |
| (Add Z 7040 and then SiS SARS & mix both with gentle agitation) | | | |
| 4) SiS 200 SARS | 12.0% (as-received) | 600 | g |
| | Total Bath Weight | 5,000 | g |

Procedure (illustrated in FIG. 12, except a heated drum roller was in tandem after the oven):

Dry-Cure

For fabrics not containing MP PE, the tunnel oven temperature and the heated contact drum rollers were set at a temperature of 121° C. with an exposure time in the oven of 90 seconds and 70 seconds on the heated drum rollers. For fabrics containing PE, the oven and drum temperatures were set at 108° C.

IV. Latex/SiS 200 SARS Antimicrobial (AM) for Finishing of Inner Cotton-Surfaced Spunbonds (CSNS) to Minimize Linting
A1. Pad-Dry-Cure Application of Noveon Hystretch V-29 Latex and SiS 200 SARS AM to CSNs for Face Mask Inner Fabric

Pad Bath Composition (for a 100% Wet Pickup of bath by fabric and total bath weight of 10,000 g)

| | Composition | Amount | |
|---|---|---|---|
| Ingredient | (Wt % of Bath) | (G/10,000 G) | |
| 1) Distilled Water | 77.75% | 7,775 | g |
| 2) 1-Octanol | 0.25% | 25 | g |
| (Disperse in water at high speed to prevent “oiling out” | | | |
| 3) Hystretch V-29 | 16.0% (as-received) | 1,600 | g |
| _ (Add Z 7040 and then SiS SARS & mix both with gentle agitation) | | | |
| 4) SiS 200 SARS | 6.0% (as-received) | 600 | g |
| | Total Bath Weight | 10,000 | g |

Procedures (illustrated in FIG. 15):

Padding

Sew re-usable leader fabrics to both ends of a 1.0 m length of pre-weighed SB fabric and weight after the dip and squeeze thru padder to determine % WPU. Repeat procedure and adjust padder nip pressure to obtain a 100% WPU.

Dry-Cure

For fabrics not containing MP PE, set the oven or drying/curing zone at temperature of 121° dry/cure in a tenter oven for three minutes. For fabrics containing MP PE, the oven temperature was to be set at 108° C.

A2. Pad-Dry-Cure Application of Noveon Hystretch V-29 Latex and SiS 200 SARS AM to CSNs for Padding Thermally Bonded Garment Fabrics Containing CSNs on the inside layer

Pad Bath Composition (for a 100% Wet Pickup of bath by fabric and total bath weight of 10,000 g)

| | Composition | Amount | |
|---|---|---|---|
| Ingredient | (Wt % of Bath) | (G/10,000 G) | |
| 1) Distilled Water | 77.75% | 7,375 | g |
| 2) 1-Octanol | 0.25% | 25 | g |
| (Disperse in water at high speed to prevent “oiling out” | | | |
| 3) Hystretch V-29 | 20.0% (as-received) | 2,000 | g |
| _ (Add Z 7040 and then SiS SARS & mix both with gentle agitation) | | | |
| 4) SiS 200 SARS | 6.0% (as-received) | 600 | g |
| | Total Bath Weight | 10,000 | g |

Procedures (illustrated in FIG. 15):

Padding

Sew re-usable leader fabrics to both ends of a 1.0 m length of pre-weighed SB fabric and weight after the dip and squeeze thru padder to determine % WPU. Repeat procedure and adjust padder nip pressure to obtain a 100% WPU.

Dry-Cure For fabrics not containing MP PE, set the oven or drying/curing zone at temperature of 121° dry/cure in a tenter oven for three minutes. For fabrics containing MP PE, the oven temperature was to be set at 108° C.

It should be noted that the spray-dry-cure application of Noveon Hystretch V-29 Latex and SiS 200 SARS AM to CSNs for topically finishing thermally bonded garment fabrics containing CSNs on the inside layer procedure could not be employed for Finish IVB (not shown) for spray application because the latex quickly plugged the small holes in the spray nozzles that were available for this procedure. Apparently, the shear forces developed with these spray nozzles was great enough to destabilize the latex emulsion and form cakes of latex particles in the nozzles. Thus the thermally bonded protective garment fabrics which contained CSNs on the inside (body-side) had to be first finished on the opposite SB side by spray application of the FC or combination FC/AM finishes followed by drying and curing in the tunnel oven and on the heated drum. Then these garment fabrics were treated with the padding formulation IVA2, followed by drying/curing in the Tenter oven. Although these later fabrics were exposed to Finish IVA2 on both sides, it was believed that the FC or FC/AM finish previously applied by the spray-dry-cure procedure to the SB side of the garment fabrics would effectively prevent minimize the pickup of IVA2 on the SB PP side. For future finishing of the thermally bonded garment fabrics containing CSNs on the body-side, it is preferable to:
1) Use a spray-dry-cure procedure with spray nozzles designed for spraying latex as well as for the other finishes as illustrated in FIG. 12
2) To apply separate or the same finishes to the two sides of the fabrics separately by foam application as illustrated in FIG. 13.
3) To apply the finishes to each side of the fabric by coating techniques such as kiss-roll coating or by knife-over-roll application as illustrated in FIG. 14.

Furthermore, for applying the different protective finishes to the un-bonded and bonded face mask and respirator laminates, it was desirable to first apply the finishes to the different inner and outer fabrics before lamination with the un-charged or charged MB PP filter media in the middle layer. However, it may be even more cost effective to first laminate the face mask or respirator components with the un-charged or charged MB PP filter media. It the media is first electrostatically charged and happens to loose some of its charge and filtering effectiveness after finishing due to exposure to moisture and heat during the finishing process, then the Tantret™ electrostatic charging technology developed by these inventors offers the unique advantage of allowing filter media in the laminate with either finished or un-finished outer fabrics to be charged by the Tantret Technique II (FIG. 16) procedure (wire-in-shell), which is demonstrated later in these specifications.

Coating Applications of Breathable Monolithic (ML) Films

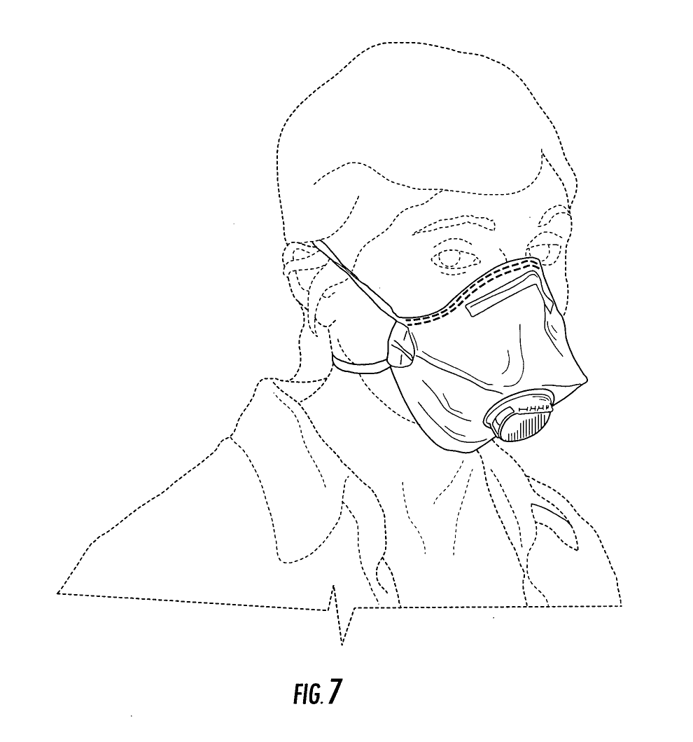

Three experimental candidate protective garment fabrics were coated on the SB PP side with a breathable monolithic film forming resin produced by Noveon Inc., known as Permax BB2415 HMVT Breathable Coating:
1) Blue SB PP outer side and white CSN inner side (Sample B/W 8-2-04) made of:
   a) Outer side of 17 gsm blue (pigmented) SB PP
   b) Middle layer of 25 gsm MP PP film
   c) Body-side layer of a Cotton-Surfaced-Nonwoven (CSN) prepared as described in FIG. 8, consiting of a 13 gsm carded 60% cotton/40% staple PP bonded to a 17 gsm SB PP
2) Blue SB PP outer side and white CSN inner side (Sample B/W 30-3) made of:
   a) Outer side of 25 gsm blue (pigmented) SB PP
   b) Middle layer of 25 gsm MP PE film
   c) Body-side layer of a Cotton-Surfaced-Nonwoven (CSN) prepared as described in FIG. 8, consiting of a 13 gsm carded 60% cotton/40% staple PP bonded to a 17 gsm SB PP
3) White CSN on both sides (W/N 8-2-04) consisting of a 20 gsm carded web of 60% cotton/40% staple PP bonded to a 12 gsm SB PP as illustrated in FIG. 8.

On the blue SB side of samples B/W 8-2-04 and B/W 30-3 and on the SB component of the CSN (WW 8-2-04), a breathable monolithic (ML) film was applied using the coating procedure described below:
Total Dry Add-on of Noveon Permax BB2415 HMVT Breathable Coating: 40.7 gsm
Two Pass Coating (double coat)
Knife-on-glass Bed (similar to FIG. 14) using a Sharp Knife Blade
Dried/Cured at 230° F. (110° C.) for 5 minutes after each coating

It should be noted that the above three ML coated samples were not further treated with FC or AM of FC/AM or Latex/AM finishes, although some of these additional finished may be applied in commercial products. Furthermore antimicrobial (AM) compounds may also be mixed with the ML coating prior to applying the coating, and other protective finishes may also be applied.

### Face Masks and Respirators

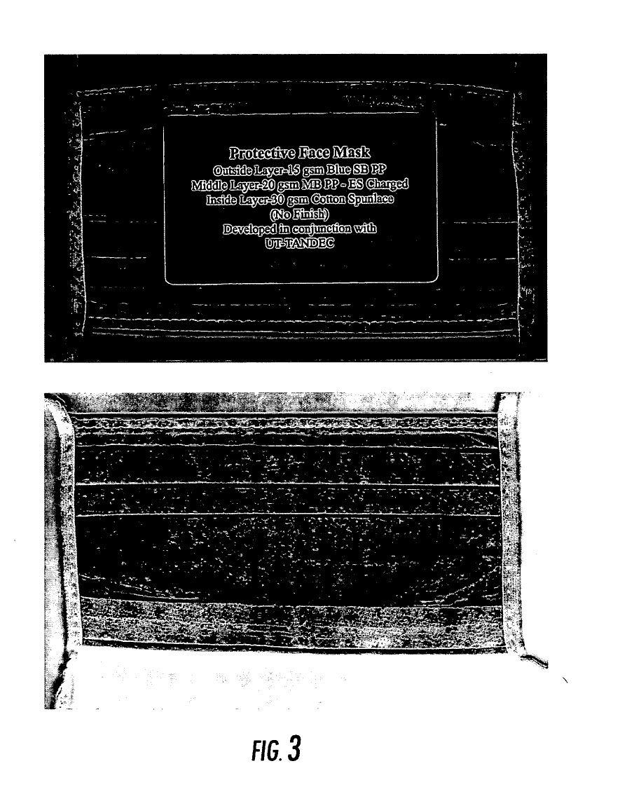

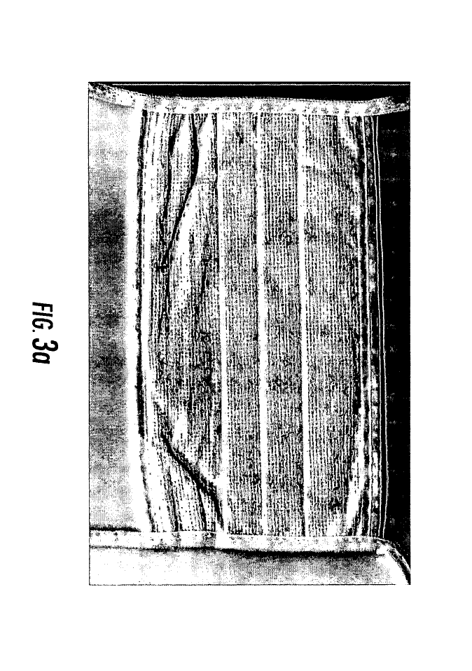

Inventive laminates for face masks and respirators have been developed with electrostatically charged MB PP filter media in the center and with which the outside layer (OL) and body-side (BS) fabric components designed for optimum application of protective finishes to either repel or deactivate airborne microbes such as the Severe Acute Respiratory Syndrome (SARS) virus. In this invention, a hydroentangled 100% cotton (HEC) nonwoven, or a cotton-surfaced SB PP (CSN) may be substituted for the white SB BS layer. When used on the inside of the FM laminate, the HEC (FIGS. 3a, 3b) or the cotton side of the CSN is worn against the face for enhanced comfort. It is also believed that the cotton components will better absorb and retain the protective finishes than SB PP.

Cotton-Surfaced Nonwovens (CSNs) were prepared (McLean, E. C., Jr., L. C. Wadsworth, Q. Sun, D. Zhang and G. Shaker, “Development of Highly Absorbent Cotton-Core Nonwovens,” Proceedings, INTC 2001, Baltimore, Md., Sep. 5-7, 2001; Wadsworth, L. C., H. S. Suh and H. C. Allen, Jr., “Cotton-Surfaced Nonwovens for Short-Wear-Cycle Apparel,” International Nonwovens Journal 9 (2), 13-17, 2000; Sun, C. Q., D. Zhang, L. C. Wadsworth and E. M. McLean, Jr., “Processing and Property Study of Cotton-Surfaced Nonwovens,” Textile Research Journal 70 (5), 449-453, 2000) as shown in FIG. 8 on the 1.0 m Reicofil 2 spunbond (SB) line at TANDEC in which 13 or 20 g/m² carded bleached cotton/PP staple fiber webs (60/40 cotton/PP) were thermally bonded to 12 or 17 g/m² SB PP webs. Prior to forming these laminates, both the outer SB or body-side fabrics may be finished with an antimicrobial (AM) agent, fluorochemical (FC) repellent, or with a combination of AM and FC to further enhance the ability of the face mask to filter, repel or kill microbes such as the SARS virus. Experiments were also conducted to determine whether better FE would be obtained by electrostatically charging the MB filter before preparing the laminates or afterwards using the charging technology invented by P. P. Tsai and L. C. Wadsworth as depicted in FIG. 8.

Results of Electrostatic Charging of Face Mask Laminates

As shown in Table 3, the average filtration efficiency (of non-electrostatically charged) of the bare MB PP microfiber web with a basis weight of 17 g/m²was only 30.07% when tested on a TSI Model 8130 Filtration Tester with 0.1 micrometer (pm) sodium chloride particles at flow rate of 32 l/min (filtration velocity of 5.1 cm/s). The pressure drop (Δp) during this test was 2.5 mm of water. However, when electrostatically charged by Tantret™ Technique I, the FE increased by three-fold to 90.29% while the average Δp differed little at 2.73 mm of water. This is the “wire-over-metal-roller” method (FIG. 8) in which the media to be charged comes into contact with a charged conductive roller with an oppositely charged wire, generally placed 1-2 inches above the roller as described by Tsai and Wadsworth. Tantret™ Technique II in these two patents is described as a “wire-inside-shell” method in which the fabric to be charged is transported by insulated rollers inside the shell with a large voltage potential between the wire and the shell. With both Techniques I and II (FIG. 16), a series of two wire-over roller units or wire-inside-shell units, in which the overall polarities of the charged surfaces of the media are reversed (positively charged side becomes negative and vice versa), has often been found to result in greater magnitudes of surface potentials and in greater FE than just subjecting the media to only one Technique I or II device. Although both Techniques I and II have been repeatedly shown to substantially increase FE of high dielectric materials such as MB PP, it has been found that Tech I results in somewhat greater efficiency than Tech II when the basis weight of the MB PP is 50 g/m² or less and that Tech II results in higher FE with MB heavier than 50 g/m². Technique II also has generally been found to result in greater FE than Tech I when charging laminates and composite fabrics.

Also in Table 3, the FE of FM Laminate 33 UC, which has an outer 25 g/m² light blue SB PP fabric, a center of 17 g/m² uncharged MB PP, and a body-side layer of 30 g/m² porous 100% cotton hydroentangled (HEC) nonwoven fabric as with the bare uncharged MB PP web has a FE of only 39.5% to 0.1 μm NaCl particles, but the Δp with the sample was significantly greater at 3.47 mm of water, although the laminate is quite easy to breathe through. Further optimization of the MB web and to a lesser extent of the other components will notably reduce this Δp . However, charging this laminate (renamed 33 CH) by Tech I with the blue SB side of the laminate against the negatively charged metal roller below the positively charged wire resulted in a substantial increase in FE to 85.6%, while the Δp stayed the same. Yet charging the FM fabric after lamination (renamed 34) by Tech I with the white HEC in contact with the metal roller resulted in an even greater FE of 91.03%, than by charging the bare MB web by Tech I prior to lamination (33 CH). The lower Δp was essentially the same and within the range of the experimental error. Previous work by Tsai et al. (Tsai, P. P., D. Qin and L. C. Wadsworth, “Effect of Aerosol Properties on the Filtration Efficiency of Meltblown Webs and Their Electrets,” Book of Papers, Fourth Annual TANDEC Conference, The University of Tennessee, Knoxville, Tenn., Nov. 14-17, 1994) has shown that a FE of 82% to 0.1 μm NaCl corresponds to an In vitro Bacterial Filtration Efficiency (BFE) to Staphylococcus aureus bacteria with a size of 1 μm, aerosolized in approximately 3 μm water droplets, of 95% and that a 90% FE with 0.1 NaCl corresponds to an In vitro BFE of 99% or greater. Thus all of these charged samples would pass the requirement of at least 95% BFE, and the charged bare MB web and Samples 34, 35X, and 36X, should have a BFE of 99% or greater. Sample 35X has the same composition as all of the other FM fabrics in Table 4, but the entire assembly comprising the laminate was charged by Tech II resulting in a FE of 90.98% to 0.1 μm NaCl. With Sample 36X, the bare MB web was charged by Tech I before the laminate was prepared, resulting in an FE of the laminate of 90.42%. Depending on the particular production setting, it appears to be advantageous to first prepare the 3-layered laminate and then charge it. The electrostatic charging also appears to cause the laminate to be better adhered due to electrostatic attraction.

In Table 4, Sample 37X UC had an outer 25 g/m² dark blue SB PP web, a middle layer of 17 g/m² uncharged MB PP and a body-side fabric of 13 g/m² carded 60%/40% cotton/staple PP web bonded to a 12 g/m² natural (white) SB PP (13 g CSN_{SB12}), with the cotton component to be worn against the face, had an FE of only 41.08% (with a Δp of 3.25 mm water). However, when this same FM construction was charged by Tech II (Sample 37X CH), the FE was 91.73% to 0.1 μm NaCl. Likewise, uncharged Sample 38 UC, which had the same composition except for a heavier cotton component of 20 g/m² carded 60 cotton/40 PP web on a 12 g/m² white SB (20g CSN_{SB12}) had an FE of 45.63% with a somewhat higher Δp of 3.78 mm water. However, the same laminate construction when charged by Tech II (38 CH) had a very high FE of 95.03% to 0.1 μm NaCl. Sample 39 CH, which was the same in construction as 38 UC and 38 CH, except the CSN consisted of 20 g/m² 60/40 C/PP on 17 g/m² white SB PP (20 g CSN_{17gSB}), was charged by Tech II, and had the highest FE (95.36%) of all the FM laminates in Tables 3 and 4. Even though the Δp was 3.93 mm of water, it was still easy to breathe through the fabric.

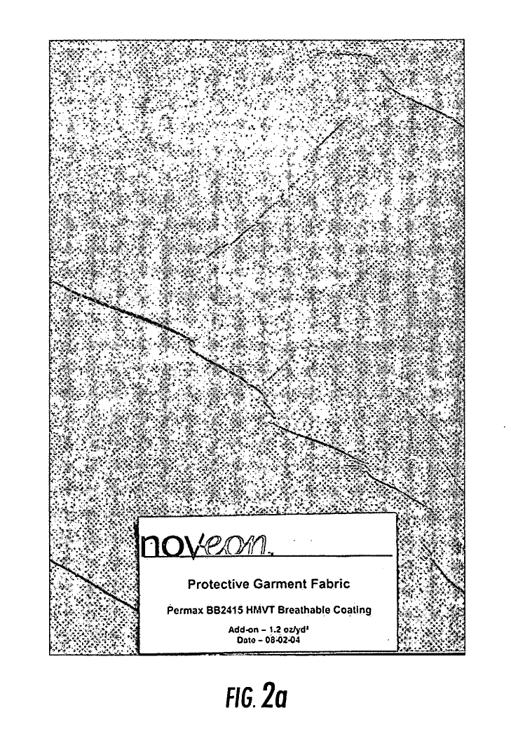

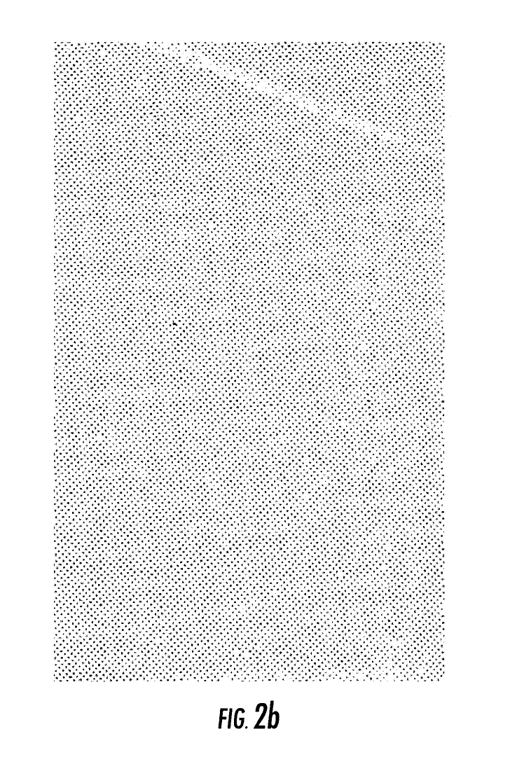

Molded cup filter composites may be electrostatically charged at different stages of production. If the molding temperature is not too high, the MB media may be charged by Tantret™ Technique I or II depending on the weight and composition of the media before it is laminated with one or more other components and molded into shape. In fact with the cup-shaped mask, it is not necessary to laminate the MB media with any thing else. A molded cup-shaped MP face mask from a one-layer MB fabric using this inventive FC treatment is the simplest embodiment of this invention. The one MB layer may be laminated to a second fabric such as a SB PP nonwoven or a CSN composite or a hydoentangled nonwoven containing a blend of cotton with thermally fusible fibers such as PP staple fibers or bi-component thermal binding fibers or mixed with thermal fusing powders or granules, as depicted in FIG. 2, before being molded into a cup-shaped mask. Furthermore, the MB PP may be electrostatically charged and the MB nonwoven or other component or the entire two-layer composite mat be treated with an AM or FC or other protective finish. Nevertheless, the cup-mask, whether it consists of only a single MB layer of varying thickness such as MB PP or a multi-component composite, may also be charged by Tantret™ Technique II (FIG. 16).

TABLE 3
Filtration Efficiency to 0.1 um NaCl and ΔP Before and After
Charging Bare MB PP Web and FM Laminates Consisting of Outer Layer
of 25 g Blue SB PP, Center of 17 g Uncharged or Charged MB PP and
Body-Side of 30 g Hydroentangled 100% Cotton [HEC]

| | | 0.1 μm NaCl Filtration Test | | |
|---|---|---|---|---|
| | | | Pene- | Fil- |
| | | ΔP | tration | tration |
| Description | | (mm H₂O) | (%) | Eff. (%) |
| 17 g of Bare MB PP | Avg. | 2.50 | 69.93 | 30.07 |
| (Uncharged) | Std | 0.10 | 0.15 | 0.15 |
| | dev | | | |
| 17 g of Charged MB PP | Avg. | 2.73 | 9.71 | 90.29 |
| (Charged by Tech I) | Std | 0.06 | 1.06 | 1.06 |
| | dev | | | |
| Sample 33 UC | Avg. | 3.47 | 60.50 | 39.50 |
| Outer Layer (OL) of 25 g Light | Std | 0.15 | 0.70 | 0.70 |
| Blue (LB) SB PP, Center of | dev | | | |
| 17 g Uncharged MB PP, Body- | | | | |
| Side (BS) Layer of 30 g HEC | | | | |
| Sample 33 CH | Avg. | 3.47 | 14.40 | 85.60 |
| OL 25 g LB SB PP, Center | Std | 0.15 | 0.62 | 0.62 |
| 17 g, MB PP, BS Layer 30 g | dev | | | |
| HEC: | | | | |
| Lam Ch by Tech I with OL on | | | | |
| Roller | | | | |
| Sample 34 | Avg. | 3.17 | 8.97 | 91.03 |
| OL 25 g LB SB PP, Center 17 g | Std | 0.12 | 0.56 | 0.56 |
| MB PP, BS 30 g HEC | dev | | | |
| Lam Ch Tech I with HEC on | | | | |
| Roller | | | | |
| Sample 35X | Avg. | 3.37 | 9.02 | 90.98 |
| OL 25 g LB SB PP, Center 17 g | Std | 0.15 | 0.49 | 0.49 |
| MB PP, BS of 30 g HEC | dev | | | |
| Lam Ch by Tech II | | | | |
| Sample 36X | Avg. | 3.27 | 9.58 | 90.42 |
| OL 25 g SB PP, Center 17 g | Std | 0.12 | 0.49 | 0.49 |
| MB PP, BS 30 g HEC | dev | | | |
| MB Ch by Tech I before | | | | |
| Lamination | | | | |

TABLE 4
Filtration Efficiency to 0.1 um NaCl and ΔP of FM Laminates
Consisting of Outer Fabric Layer of 25 g Pigmented SB PP,
Center of 17 g Uncharged or Charged MB PP and Body-Side of
13 g or 20 g Carded Webs of 60% Cotton/40% PP on 12 g or 17
g White SB PP [CSN_{12 g SB} and CSN_{17 g SB}]

| | | 0.1 μm NaCl Filtration Test | | |
|---|---|---|---|---|
| | | ΔP | Pene- | |
| | | (mm | tration | Filtration |
| Description | | H₂O) | (%) | Eff (%) |
| Sample 37X UC | Avg. | 3.25 | 58.93 | 41.08 |
| Outer Layer (OL) of 25 g Dark | Std dev | 0.53 | 4.25 | 4.65 |
| Blue (DB) SB PP, Center 17 g | | | | |
| Uncharged MB PP, Body-Side | | | | |
| Layer of 13 g CSN_{12 g SB}) | | | | |
| Sample 37X CH | Avg. | 3.45 | 8.27 | 91.73 |
| OL 25 g DB SB PP, Center17 g | Std dev | 0.57 | 2.14 | 1.21 |
| MB PP, BS 13 g CSN_{12 g SB}) | | | | |
| FM Laminate Charged by | | | | |
| Tech II | | | | |
| Sample 38 UC | Avg. | 3.78 | 54.38 | 45.63 |
| OL 25 g Light Green (LG) SB | Std dev | 0.63 | 7.25 | 8.13 |
| PP, Center 17 g Uncharged | | | | |
| MB PP, BS of 20 g CSN_{12 g SB}) | | | | |
| Sample 38 CH | Avg. | 3.95 | 4.97 | 95.03 |
| OL 25 g LG SB PP, Center17 g | Std dev | 0.75 | 1.93 | 1.93 |
| MB PP, BS 20 g CSN_{12 g SB}) | | | | |
| FM Laminate Charged | | | | |
| byTech II | | | | |
| Sample 39 CH | Avg. | 3.93 | 4.64 | 95.36 |
| OL 25 g LG SB PP, Center 17 g | Std dev | 0.50 | 0.94 | 0.94 |
| MB PP, BS 20 g CSN_{17 g SB}) | | | | |
| FM Laminate Charged by | | | | |
| Tech II | | | | |

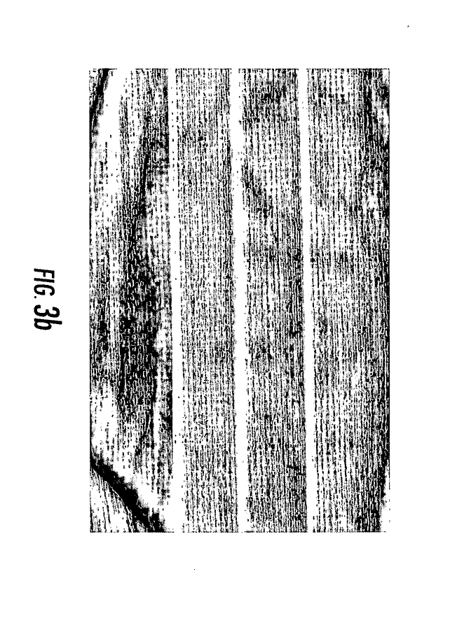

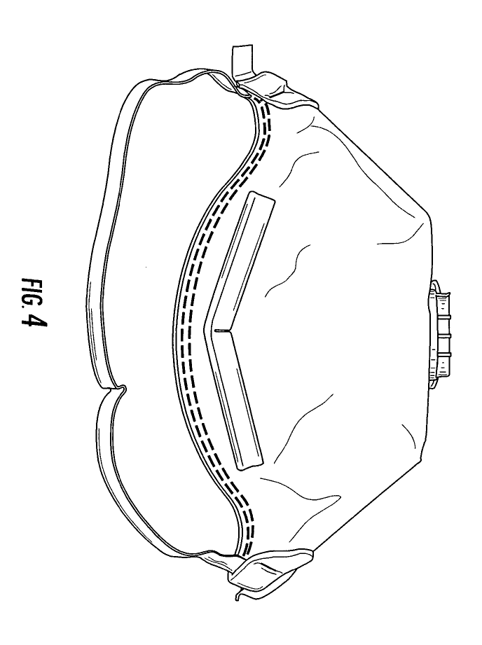

As shown in Table 5, additional MB PP webs were produced at TANDEC with weights of 18, 25 and 30 g/m² and tested for FE to nominal 0.1 μm NaCl on the TSI Model 8130 tester at a flow rate of 32 l/min (face velocity of 5.3 cm/s) both before and after charging the MB media by Tantret Technique I. Again charging dramatically increased the FE of all three weights of webs. By manipulating the melt blowing processing conditions, it was possible to produce an 18 gsm MB PP web with a Δp with the same FE test conditions of only 1.8 mm H₂O compared to 2.5 mm H₂O with the 17 g MB PP for the earlier study (Table 3). Although the new 18 gsm MB PP web had a lower FE of 25.48% uncharged compared to the first 17 gsm MB PP which had a FE of 30.07%, the FE of the charged 18 gsm MB PP webs was higher at 95.13%, compared to 90.29% with the 17 gsm web. Typically, MB web weights of 17-20 gsm (FIG. 3, FIG. 3a, FIG. 3b) are made for three-ply surgical face mask fabric and weights of 25 to 30 gsm and higher are used to produce molded cup-shaped masks or respirators (FIG. 4, FIG. 4a, 4b). As shown in Table 5, the Technique I charged 25 and 30 gsm bare MB webs have FEs of 98.24% and 98.28%, with corresponding Δp values of 2.78 to 3.15 mm H₂O, which are still easy to breath through. As can be seen from the standard deviation values there are no significant differences in Δp between the un-charged and charged webs of the same weight.

As noted in Table 6, outer layer (OL) SB PP webs and body-side (BS) CSNs that were treated with different FC, AM, Latex and combinations of these protective finishes (treated with Finish Formulas: Finish IA-FC only on OL; IIIA-FC+AM on OL and BS; and IVA1−Latex+AM on BS CSN with Sample 11-23-6; and IVA2−Latex+AM on BS CSN with Sample 11-23-7. The MB web weights in the first five samples in Table V were 25 gsm and the MB weight in the last two samples was 18 gsm. It is remarkable that extremely high filtration efficiencies ranging from a low of 95.89% to a high of 98.58% were obtained by laminating un-charged 18 and 25 gsm MB webs with OL SB and BS CSN fabrics which had already been finished, and that the finishes on the OL and BS fabrics (even the BS with Latex+AM) apparently had little or no detrimental effects on the ability to charge the MB PP media as a laminate between the finished facing and backing fabrics by Tantret Technique II, which allows much flexibility as to the processing steps in the finishing, laminating and electrostatic charging steps in producing the inventive face mask and respirator laminate fabrics. It is also apparent that the fabric may also be first laminated, treated with finishes on either side, preferably by topical treatments such as spraying, kiss roll or knive-over-roller coating, or by foam finishing, and then the finished laminate may be very efficiently charged by Technique II.

In summary, electrostatic charging of the 17 g/m² MB PP filter media by Tantret™ Tech I (wire-over-roller) increased the FE to 0.1 μm NaCl particles by three-fold from 30 to 90%. By combining Tech I charged MB PP as a center layer between an outer pigmented SB PP web and a body-side porous 30 g/m² hydroentangled 100% cotton (HEC) nonwoven, the FE remained at 90%. It was also found that if a non-charged 17 g/m² MB PP was used to form the same structure, that the 3-ply laminate could then be effectively charged by Tantret™ Tech I, but a higher FE of 91% was obtained if the HEC side was in contact with the charged metal roller with the outer SB side facing the charged wire. Conversely, a somewhat lower FE of 85.6% resulted when the SB side contacted the roller and the HED was beneath the wire. A very high FE of 91% resulted when this laminate with uncharged MB PP was charged by Tantret™ Tech II (wire-inside-shell). These results reveal a great deal of flexibility in the production of FM laminates with electrostatically charged filter media using the Tantret™ charging system. Furthermore, charging the 3-ply FM appears to cause the laminate layers to be better adhered due to electrostatic attraction.

Even higher FE values to 0.1 μm NaCl particles ranging from 91.7 to 95.4% were obtained from charging by Technique II the 3-ply FM laminates containing an outer pigmented 25 g/m² SB PP, center layer of 17 g/m² MB PP and body-side Cotton-Surfaced Nonwovens (CCNs). The 95% FE values were obtained with the CSNs based on both 12 and 17 g/m² SB PP webs which had the heavier 20 g/m² carded 60% cotton/40% PP staple webs bonded to the SB, as opposed to the FM containing the 13 g/m² carded cotton/PP web, which had the 91.7% FE.

TABLE 5
Filtration Efficiency to 0.1 um NaCl and ΔP Before
and After Charging Bare MB PP Webs with Weights of 18,
25 and 30 g/m² by Tantret ™ Technique I

| | | 0.1 μm NaCl Filtration Test | | |
|---|---|---|---|---|
| | | | Pene- | |
| | | ΔP | tration | Filtration |
| Description | | (mm H₂O) | (%) | Eff. (%) |
| 18 g of Bare MB PP | Avg. | 1.8 | 74.53 | 25.48 |
| (Uncharged) | Std | 0.08 | 1.06 | |
| | dev | | | |
| 18 g of Charged Bare MB PP | Avg. | 2.10 | 4.87 | 95.13 |
| (Charged by Tech I) | Std | 0.18 | 0.50 | |
| | dev | | | |
| 25 g of Bare MB PP | Avg. | 2.45 | 66.68 | 33.33 |
| (Uncharged) | Std | 0.26 | 2.69 | |
| | dev | | | |
| 25 g of Charged Bare MB PP | Avg. | 2.78 | 1.77 | 98.24 |
| (Charged by Tech I) | Std | 0.10 | 0.19 | |
| | dev | | | |
| 30 g of Bare MB PP | Avg. | 3.10 | 59.65 | 40.35 |
| (Uncharged) | Std | 0.20 | 1.84 | |
| | dev | | | |
| 30 g of Bare MB PP | Avg. | 3.15 | 1.72 | 98.28 |
| (Charged by Tech I) | Std | 0.17 | 0.55 | |
| | dev | | | |

TABLE 6
Filtration Efficiency to 0.1 um NaCl and ΔP of FM Laminates
Charged by Technique II Consisting of Finished Outer Fabric Layer
of Pigmented SB PP, Center of 18 g or 25 g MB PP and Body-Side
of Finished 13 g or 20 g Carded Webs of 60% Cotton/40% PP on 12
g or 17 g White SB PP [CSN_{12 g SB} and CSN_{17 g SB}]

| | | 0.1 μm NaCl Filtration Test | | |
|---|---|---|---|---|
| | | ΔP | Pene- | Fil- |
| | | (mm | tration | tration |
| Description | | H₂O) | (%) | Eff (%) |
| Sample 11-23-1 | Avg. | 2.93 | 1.42 | 98.58 |
| Outer (OL) of 25 g Phthalo (Ph) | Std dev | 0.21 | 0.29 | |
| Blue SB PP 41A (Fin IIIA- | | | | |
| FC/AM), Center 25 g MB PP, | | | | |
| Body-Side of 13 g CSN_{12 g SB} | | | | |
| 42B (Fin IIIA-FC/AM) | | | | |
| Sample 11-23-2 | Avg. | 2.45 | 3.92 | 96.08 |
| OL 25 g Ph SB PP (Fin IIIA- | Std dev | 0.13 | 0.53 | |
| FC/AM), Center 18 g MB PP, | | | | |
| BS 13 g CSN_{12 g SB} | | | | |
| 42B (Fin IIIA-FC/AM) | | | | |
| Sample 11-23-3 | Avg. | 2.55 | 4.11 | 95.89 |
| OL 25 g Light Blue (LB) SB PP | Std dev | 0.19 | 0.67 | |
| 41A (Fin IA-FC only), Center | | | | |
| 18 g MB PP, BS of 20 g | | | | |
| CSN_{17 gSB} 44B (Fin IIIA- | | | | |
| FC/AM) | | | | |
| Sample 11-23-4 | Avg. | 2.40 | 3.69 | 96.31 |
| OL 25 g LB SB PP 45A (Fin | Std dev | 0.12 | 0.64 | |
| IIIA-FC/AM), Center 18 g MB | | | | |
| PP, BS 20 g CSN_{17 g SB}) 44B | | | | |
| (Fin IIIA-FC/AM) | | | | |
| Sample 11-23-5 | Avg. | 2.65 | 3.53 | 96.47 |
| OL 25 g Pb SB PP 43A (Fin | Std dev | 0.13 | 0.46 | |
| IIIA-FC/AM), Center 18 g MB | | | | |
| PP, BS 20 g CSN_{17 g SB}) 44B | | | | |
| (FinIIIA-FC/AM) | | | | |
| Sample 11-23-6 | Avg. | 2.63 | 3.87 | 96.13 |
| OL 17 g Ph SB PP 24A (Fin | Std dev | 0.15 | 0.48 | |
| IIIA-FC/AM), Center 18 g MB | | | | |
| PP, BS 20 g CSN_{17 g SB})24B (Fin | | | | |
| IVA1-Latex/AM) | | | | |
| Sample 11-23-7 | Avg. | 2.60 | 3.32 | 96.69 |
| OL 25 g LB SB PP 45A (Fin | Std dev | 0.12 | 0.42 | |
| IIIA-FC/AM), Center 18 g MB | | | | |
| PP, BS 13 g CSN_{12 g SB})45B (Fin | | | | |
| IVA2-FC/AM) | | | | |

The ΔP of the bare 17 g/m² MB PP was 2.5 mm water during the FE test on the TSI instrument. In work that is in progress, the ΔP of the same weight MB PP has been reduced to 1.9 mm with similar FE after charging. Lamination of the MB PP in this study with an outer 25 g/m² SB PP and with a body-side porous 30 g/m² HEC increased the ΔP from 2.5 mm to an average of 3.35 mm water and the FM laminates containing the 13 g/m² carded cotton/PP web on the 12 g/m² SB had an average ΔP of 3.35 mm water. The FM laminates containing the 20 g/m² carded cotton/PP on 12 and 17 g/m² SB webs had a slightly higher average ΔP of 3.89 mm. However all of the FM laminates were easy to breathe through.

By manipulating the melt blowing processing conditions, it was possible to produce a new 18 gsm MB PP web with a Δp with the same FE test conditions of only 1.8 mm H₂O compared to 2.5 mm H₂O with the 17 g MB PP for the earlier study. Although the new 18 gsm MB PP web had a lower FE of 25.48% uncharged compared to the first 17 gsm MB PP which had a FE of 30.07%, the FE of the charged 18 gsm MB PP webs was higher at 95.13%, compared to 90.29% with the 17 gsm web. Also additional MB webs with weights of 25 and 30 gsm were produced and the bare MB webs were charged by Tantret Technique I resulting in FEs to 0.1 μm NaCl of 98.24% and 98.28%, with corresponding Δp values of 2.78 to 3.15 mm H₂O, which are still easy to breath through.

It is remarkable that extremely high filtration efficiencies ranging from a low of 95.89% to a high of 98.58% were obtained by laminating un-charged 18 and 25 gsm MB webs with OL SB and BS CSN fabrics which had already been finished, and that the finishes on the OL and BS fabrics (even the BS with Latex+AM) apparently had little or no detrimental effects on the ability to charge the MB PP media as a laminate between the finished facing and backing fabrics by Tantret Technique II, which allows much flexibility as to the processing steps in the finishing, laminating and electrostatic charging steps in producing the inventive face mask and respirator laminate fabrics. It is also apparent that the fabric may also be first laminated, treated with finishes on either side, preferably by topical treatments such as spraying, kiss roll or knife-over-roller coating, or by foam finishing, and then the finished laminate may be very efficiently charged by Technique II.

In Table 7, the 0.1 μm NaCl FE performed at TANDEC and the Bacterial Filtration Efficiency (BFE) was performed using an aerosol of Staphylococcus aureus at Nelson Laboratories, Salt Lake City, Utah, based on Military Specification 36954C, on representative face mask laminates (FM) of this invention in which the top SB PP fabrics (outside layer or OL) were treated with FC or FC+AM finishes, and the inside layer (body side layer or BS) SB, CSN or 100% cotton hydoentangled cotton (HEC) fabrics were finished with AM, FC+AM or Latex+AM finishes. The middle MB PP nonwoven fabrics were either charged before lamination as bare MB by Tantret Technique I or as laminate with the original facings on each side before finishing by Tantret Technique II. As noted earlier in this document, OL and BS fabrics were removed from the laminate containing the charged MB webs and were replaced in the same manner after they were finished. FM laminates 33 and 35X for tested for NaCl FE at TANDEC as laminates before finishing (BF) in which the FEs were 85.6% and 91.0%. After the OL and BS layers were removed, treated with the protective finishes noted in the table and re-laminated, the FE values dropped to 78.7% and 80.6%, respectively. By first preparing the FM laminates and applying the different topical finishes as appropriate to the OL and BS layers, and then charging the finished laminate by Technique II, the data in this study strongly indicates that the NaCl values can be maintained extremely high by not having to separate and handle the laminates as much. Nevertheless, the BFE values which were determined on the re-laminated fabrics after finishing were still 98.5% and 99.6%. Sample 12 and 15 have the same compositions (SB PP OL and SB PP BS with no cotton) and finishes, except the MB PP in Sample 12 is not charged. The NaCl FE of Sample 12 is 38% and the BFE at 94.3% is below the acceptable level of 95%. Sample 15 in which the MB PP had been charged by Technique I had an FE of 86% and a BFE of 99.3%. However, Samples 12 and 15 felt very flimsy compared to the FM samples which had cotton on the inside layers, and did feel as comfortable when held against the human face. All of the samples with charged MB PP filter media and with the different finishers on the OL and BS layers had very high NaCl FE values and BFEs ranging from 98.5%-99.6%.

As shown in Table 9, the Viral Penetration Efficiency (VFE) was determined by Nelson Laboratories on three of the same samples as from Table 7, by following the same procedure as for the BFE and using the same virus as for the Viral Penetration Test (Phi-X174). The VFE values are very high ranging from 99.0%-99.6%.

In Table 9, the moisture vapor transmission rate (MVTR) values are reported as the grams of water per square meter of fabric for 24 hours. The MVTR for the 25 gsm Aptra™ Classic microporous (MP) film itself was reported by its manufacturer to be 5000 g/m²/24 hr as tested by ASTM E96, Procedure B. The unfinished thermally bonded Protective Garment Fabrics were tested by China Standard GB/T 12704-91, which is equivalent to ASTM E96, Procedure B. Samples 29-1A and 29-1B are replicate samples which both have a top layer (OL) of 25 gsm SB PP, middle layer of 25 gsm MP PP and inside (BS) CSN composed of a carded 20 gsm 60% cotton/40% staple PP web bonded to a 17 gsm SB PP. Sample 29-2A is similar except the BS CSN composite has a lighter 13 gsm carded 60/40 cotton/PP web bonded to a 17 gsm SB PP. The MVTR of all three of these samples are considered high for good thermal comfort, ranging from 3275-3635 g/m²/24 hr. However, thermally bonded B/W 30-3 has the same construction as Sample 29-2A, except it has a 25 gsm EXXAIRE® MP PE film in the middle layer, but has over twice the MVTR (7805 g/m²/24 hr) as the garment samples with MP PP in the center. Furthermore, the sample with MP PE has a much softer hand than those with MP PP and is also much less noisy when squeezed or flexed.

In Table 10, the Synthetic Blood Penetration tests as determined at TANDEC by ASTM F 1670-98 of thermally bonded Un-Finished Protective Garment Fabrics are given. Replicate Samples 29-1A and 29-1B which have a 25 gsm MP PP film and a BS CSN with 20 gsm of 60/40 cotton/staple PP on 17 gsm SB passed in that none of the three specimens that were tested from each sample showed any evidence of synthetic blood penetration under 2 psi air pressure and after one hour of sitting without applied pressure. Also the 25 gsm Aptra MB PP film tested alone passed ASTM 1670. It would be anticipated that unless the thermal bonding conditions were precisely controlled that bonding would increase the likelihood of pin hole formation. However, Sample 29-2A, which was similar but had the lighter CSN with 13 gsm cotton/PP on 17 gsm SB PP had one specimen to fail so the sample is recorded as a failure. The 25 gsm EXXAIRE® MP PE film passed the synthetic blood penetration test, but Sample B/W 30-3, which has the middle layer of 25 gsm MP PE failed the test. Sample B/W 8-2-04 without the Permax ML breathable coating also failed 1670. Also, not surprisingly the CSN Sample W/W 8-2-4 consiting only of 20 gsm of 60/40 cotton/PP on 12 gsm SB PP without the ML coating failed ASTM 1670 immediately, even before pressure could be applied to the sample holder.

As shown in Table 11, all of the finished protective garment samples 1-7, which were the 29-1A and 29-1B identical samples and from 29-2A before finishing, passed ASTM 1670. Furthermore, the thermally bonded laminates B/W 8-2-04 with the MP PP film and Sample B/W 30-3 with the MP PE film passed 1670, but most surprising was the fact that the simple CSN Sample W/W 8-2-04 with the Permax ML coating on the SB side passed the Synthetic Blood Penetration Test. This means that the ML coated Sample W/W 8-2-04 meets the requirements for the highest level of protection, Level 4, for surgical drapes drape accessories, even though no repellent finish has been applied yet to the ML coated CSN. To be classified as Level 4 for surgical gowns and other protective apparel, the sample would have to pass the Viral Penetration Test (ASTM F1671). These specifications are found in “Liquid barrier performance and classification of protective apparel and drapes intended for use in health care facilities,” American National Standard, ANSI/AAMI PB70:2003.

As shown in Table 12, the Viral Penetration Test F 1670-98, was passed by only one protective apparel fabric, Sample B/W 8-2-04 with the Permax BB2415 HMVT Breathable Coating. This is also remarkable since this ML coated fabric has not been repellent finished. The ML coated laminate can be made even more protective by adding an AM agent to the ML coating and or applying the AM and possibly AM+FC finishes to the OS and BS sides of the laminate.

These inventors requested Nelson Laboratories to develop a special test for the face mask laminates which had never been requested before. Special Protocol No.200329401-01 was developed for performing a modified AATCC Test Method 100-1999, “Antibacterial Finishes on Textile Materials.” AATCC 100-1999 provides the protocol details for assessing antimicrobial finishes on textile materials. The challenge procedure consists of inoculating swatches of the test material with the test organism, and then determining the percent reduction of the test organism after specified exposure periods. The modification requested by these inventors was to use the actual BFE test with the aerosol of Staphylococcus aureus as the challenge procedure. The face mask samples in Table 13 were among the same samples in which the BFE results were reported in Table 7. For each sample an unfinished control was also performed for comparison. Immediately after each BFE test the specimens were removed and all three layers were extracted together and allow to sit for 24 hours and then the reduction in the number of colonies compared to the unfinished control were determined. In Table 15, Sample 15 which had FC+AM on the OS SB, a charged MB core, and a CSN in the BS layer treated with FC+AM had a 99.99+% reduction in bacteria or a Log 10 reduction of 4.75. This confirms that the AM finish or other treatments or properties of the samples are extremely effective in killing bacteria deposited by an aerosol on the fabric. Likewise, Sample 35X which had the 30 gsm HEC on the BS treated with AM only resulted in the same phenomenal kill rate. Sample 35X, which had no protective finishes, but had a charged MB PP in the middle layer had a reduction of 63% of the bacteria log 10 of 0.43). It is possible that some killing of the bacteria was the result of the positive and negative charges, particularly the positive charges, in the MB media. Also some natural fibers such as hemp, flax, and possibly cotton, are believed to have some antimicrobial properties. Perhaps grey cotton, flax or hemp may have even greater antibacterial performance. These inventors have readily produced CSN using both un-scoured cotton gin motes, as well as bleached gin motes and waste cotton. Sample 37X, which had a FC on the OS, charged MB PP in the middle and aCSN with AM only also had a 99.99+% kill rate. However, the control for sample 37X which had no protective finishes, but a charged MB PP also had a 99.99+% kill rate, possibly indicating that the charging may be playing a role in killing bacteria. To help answer this question a more compressive set of finished face mask and protective garment samples went sent to the China Quartermaster Institute in Beijing, China. These results will be in the discussion concerning Tables 17, 18 and 19.

Table 14 gives the test results of the MTCC Test Method 100-99, which were performed by Nelson Laboratories. In this test both the OS SB and BS CSN layers were inoculated with S. aureus organisms. It can be seen that with Sample 1, in which the OS SB was finished only with FC that there was no effectiveness of the FC finish on the SB in killing bacteria. However, the CSN side treated with AM only had a 99.963% reduction (log 10 g kill rate of 3.43). When the OS SB PP side in Sample 2 was finished with FC+AM, the kill rate was greater than Sample 1 at 84% (log 10 reduction of 0.79), but was much lower than the CSN BS which was finished with Latex+AM (99.939% reduction; 3.22 log 10 g reduction). With Sample 7, the OS SB was also treated with FC+AM, but did not kill bacteria. On the other hand, the CSN on the BS with FC+AM had a 99.59% kill rate (log 10 2.39). This supports the premise of the inventors that the cotton component can be more effectively finished with antibacterial agent than the synthetic hydrophobic fabrics such as SB PP. The relatively small amount of cotton on the CSN also gives the bonded laminate more body than if SB PP was used on both sides, and the cotton feels more comfortable against human skin.

Table 15 describes the protective garment fabrics which were sent to the China Quartermaster for Anti-bacterial testing. Table 16 describes the face mask samples sent there as well. For each treatment of interest, an un-treated sample was also enclosed. In Table 17, the anti-bacterial testing with the yellow grape coccus, ATCC No.6538, confirms the results of the AATCC 100-99 Test with S. aureus bacteria by Nelson Laboratories reported in Tables 13 and 14, in that the Garment Sample 3, which had FC+AM on the OS SB and Latex+AM on the BS CSN showed an anti-bacterial efficiency of 99.95%; whereas, the Control Garment Sample with no protective finishes had no anti-bacterial activity. Also finished Face Mask laminates 37Y, 35X and 35Y showed 99.86%-99.88% kill rates, while the un-treated controls showed no anti-bacterial activity, as further agreement with the testing by Nelson Laboratories. However there was also possibly a “false-negative” test with Sample 37X, which showed no anti-bacterial activity, which had demonstrated a 99.99+% kill rate with S. aureus in Table 13.

In Table 18, some of the same samples that were tested with the yellow grape coccus were tested by ATCC No. 6538 with S. aureus bacteria. The anti-bacterial property was measured according to the Shaking Bottle Method at the China Quartermaster Institute. The specimen was cut from the nonwoven sample to yield a weight of 0.075 g±0.05 g and was placed into the bottle of bacteria water and was shaken for 12 hours with 120 rpm at 37±1° C. The anti-bacteria efficiency was calculated as follows:
Y=(A−B)/A×100
In which, Y is the anti-bacteria efficiency
A is the bacteria concentration of the control sample and
B is the bacteria concentration of the tested sample.
   Sample 37X also showed somewhat low anti-bacterial efficiency of 30.53%. However, 37X has only FC on the OS SB and AM only on the CSN side. On the other hand, 37Y had FC+AM on the OS SB and Latex+AM on the CSN side and had a kill rate of 99.95%.Samples 35X and 35Y, which had a 30 gsm 100% cotton hydroentangled nonwoven on the inside, which were treated with AM only consistently had 99.90% anti-bacterial activity. This data lends even more support to the probability that cotton is easier to finish with AM agents because it absorbs the finish from aqueous treatment baths more readily. There is much less cotton in the 13 gsm of cotton/PP in the CSN of Sample 37X. There is strong evidence that CSNs with latex+AM finish are highly anti-bacterial, although the concentration of AM was increased when mixed with latex to compensate for more of the AM being bound up by the latex per the recommendations of SiShield. However, Garment Sample 7 which showed low anti-bacterial activity in Table 14 on the OS SB side but 99.59% kill rate on the CSN side treated with FC+AM demonstrated no anti-bacterial activity. It is possible that Sample 7 was tested on the OS SB side in Tables 18 and 19 instead of on the CSN side. The same procedures were followed in testing these samples as reported in Table 19, except while performing the tests in Table 18, some control samples exhibited anti-bacterial properties and thus another control was selected which had no anti-bacteria property.

Samples 21-30-4, 21A-25-5, 21A-18-1 and 21-30-3 which had no protective finishes on the OS or BS layers, but were electrostatically charged were compared to corresponding control samples which were not charged to determine if electrostatic charge results in anti-bacterial activity. In Tables 18 and 19, all of the non-charged samples showed no anti-microbial activity. However, Samples 21A-18-1 in which the MB PP was charged by Tantret Technique I showed 99.52% and 99.7% kill rates in both Tables 18 and 19, although charged Samples 21A-25-5 (charged by Technique I0 and 21-30-3 (charged by Technique II) showed no anti-bacterial activity in Table 18 but 59.09% and 74.72% in Table 19. The results are mixed, but there appears to be some support for the electrostatically charged MB to have some anti-microbial activity.

TABLE 7
Bacterial Filtration Efficiency (BFE) and 0.1
μm NaCl FE of Selected Face Mask Laminates

| Composition/Finish | | | | | | |
|---|---|---|---|---|---|---|
| Sample | | | | BFE Tests | | NaCl |
| No. | Top | Middle | Inside | BFE % | ΔP (um, H₂O) | 0.1 μm FE |
| 12 | 17 g SB | Unch | 17 g SB PP | 94.3 | 3.5 | 38 |
| | PP | 17 g MB | FC + AM | | | |
| | FC + AM | PP | | | | |
| 15 | Same | TI Ch | Same | 99.3 | 2.6 | 86 |
| | | MB PP | | | | |
| 28 | 17 g SB | TI Ch | 13 g C/17 SB | 98.7 | 2.3 | 76.5 |
| | PP | MB PP | Latex + AM | | | |
| | FC + AM | | | | | |
| 33 | 25 g SB | TI Ch | 30 g HEC | 98.5 | 2.6 | 78.7 |
| | PP | MB PP | AM Only | | | 85.6BF |
| | FC + AM | | | | | |
| 35X | 25 g SB | TII Ch | 30 g HEC | 99.6 | 2.8 | 80.6 |
| | PP | MB PP | AM Only | | | 91.0BF |
| | FC Only | | | | | |
| 37X | 25 g SB | TII Ch | 13 g C/12 SB | 99.2 | 2.7 | 85.3 |
| | PP | MB PP | AM Only | | | |
| | FC Only | | | | | |
| 43 | 25 g SB | TI Ch | 13 g C/12 SB | 98.1 | 2.2 | 84.4 |
| | PP | MB PP | Latex + AM | | | |
| | FC + AM | | | | | |

TABLE 8
Viral Filtration Efficiency (VFE)
of Selected Face Mask Laminates

| Composition/Finish | | | | VFE Tests | |
|---|---|---|---|---|---|
| Sample | | | | | ΔP |
| No. | Top | Middle | Inside | VFE % | (um H₂O) |
| 28 | 17 g SB | TI Ch | 13 g C/17 SB | 99.3 | 2.3 |
| | PP | MB PP | Latex + AM | | |
| | FC + AM | | | | |
| 37X | 25 g SB | TII Ch | 13 g C/12 SB | 99.6 | 2.7 |
| | PP | MB PP | AM Only | | |
| | FC Only | | | | |
| 43 | 25 g SB | TI Ch | 13 g C/12 SB | 99.0 | 2.2 |
| | PP | MB PP | Latex + AM | | |
| | FC + AM | | | | |

### Breathable Protective Garment Fabrics

TABLE 9
MVTR of Un-Finished Garment Fabrics

| Sample No./Description | | | | |
|---|---|---|---|---|
| Sample | | | | MVTR |
| No. | Top | Middle | Inside | (g/m²/24 hrs) |
| — | | 25 g Aptra ™ | | 5000* |
| | | Classic PP | | |
| | | MP Film | | |
| 29-1A | 25 g | 25 g MP PP | 20 g C/17 g | 3635 |
| Control | SB PP | | SB PP | |
| 29-1B | 25 g | 25 g MP PP | 20 g C/17 g | 3275 |
| | SB PP | | SB PP | |
| 29-2A | 25 g | 25 g MP PP | 13 g C/17 g | 3305 |
| | SB PP | | SB PP | |
| B/W 30-3 | 25 g | 25 g EXXAIRE ® | 13 g C/17 g | 7805 |
| | SB PP | PE MP film | SB PP | |

*Supplier's specification

TABLE 10
Synthetic Blood Penetration of Un-Finished
Protective Garment Fabrics

| | | | | Synthetic | |
|---|---|---|---|---|---|
| Sample No./Description | | | | Blood | |
| Sample | | | | Penetration | |
| No. | Top | Middle | Inside | Pass | Fail |
| — | | 25 g Aptra ™ | | XXX | |
| | | Classic | | | |
| | | PP MP Film | | | |
| 29-1A | 25 g | 25 g MP PP | 20 g C/17 g | XXX | |
| Control | SB PP | | SB PP | | |
| 29-1B | 25 g | 25 g MP PP | 20 g C/17 g | XXX | |
| | SB PP | | SB PP | | |
| 29-2A | 25 g | 25 g MP PP | 13 g C/17 g | XX | X |
| | SB PP | | SB PP | | |
| — | | 25 g EXXAIRE ® | | XXX | |
| | | PE MF | | | |
| B/W 30-3 | 25 g | 25 g MP PE | 13 g C/17 g | | XXX |
| | SB PP | | SB PP | | |
| B/W 8-2- | 17 g | 25 g MP PP | 13 g C/17 g | | XXX |
| 04 | SB PP - | | SB PP | | |
| w/o ML F | Not | | | | |
| | Coated | | | | |
| W/W8-2-04 | Not | — | 20 g C/12 g | | XXX |
| w/o ML F | coated | | SB PP | | |

TABLE 11
Synthetic Blood Penetration of Finished
or ML Film Coated Fabrics

| Sample No./Description/Finish | | | | Synthetic | |
|---|---|---|---|---|---|
| Sample | | | | Blood Penetration | |
| No. | Top | Middle | Inside | Pass | Fail |
| 1 | 25 g SB | MP PP | 20 g C/17 g SB | XXX | |
| | FC Only | | AM Only | | |
| 2 | 25 g SB | MP PP | 20 g C/17 g SB | XXX | |
| | FC + AM | | FC + AM | | |
| 3 | 25 g SB | MP PP | 20 g C/17 g SB | XXX | |
| | FC + AM | | Latex + AM | | |
| 4 | 25 g SB | MP PP | 20 g C/17 g SB | XXX | |
| | FC Only | | Latex + AM | | |
| 5 Same | | | | XXX | |
| As 3 | | | | | |
| 6 | 25 g SB | 25 g MP PP | 13 g C/17 g SB | XXX | |
| | FC Only | | Latex + AM | | |
| 7 | 25 g SB | 25 g MP PP | 13 g C/17 g SB | XXX | |
| | FC + AM | | FC + AM | | |
| B/W8-2- | 17 g | 25 g MP PP | 13 g C/17 g | XXX | |
| 04 | SB PP - | | SB PP | | |
| ML Film | Coated | | | | |
| | w 40.7 g | | | | |
| | ML Film | | | | |
| B/W 30-3 | 25 g | 15 g MP PE | 13 g C/17 g | XXX | |
| | SB PP | | SB PP | | |
| | Coated | | | | |
| | w 44.7 g | | | | |
| | ML | | | | |
| | Film | | | | |
| W/W8-2- | Coated | — | 20 g C/12 g | XXX | |
| 04 | w 40.7 g | | SB PP | | |
| ML Film | ML Film | | | | |

TABLE 12
Viral Penetration of Protective Garment Fabrics (Pass/Fail)

| Sample No./Description/Finish | | | | Viral | |
|---|---|---|---|---|---|
| Sample | | | | Penetration | |
| No. | Top | Middle | Inside | Pass | Fail |
| 1 | 25 g SB PP | MP PP | 20 g C/17 g SB | X | XX |
| | FC Only | | AM Only | | |
| 3 | 25 g SB PP | MP PP | 20 g C/17 g SB | X | XX |
| | FC + AM | | Latex + AM | | |
| 7 | 25 g SB PP | MP PP | 13 g C/17 g SB | XX | X |
| | FC + AM | | Latex + AM | | |
| BW 8-2- | 17 g | 25 g MP PP | 13 g C/17 g | | XXX |
| 04 | SB PP - Not | | SB PP | | |
| w/o ML F | Coated | | | | |
| B/W8-2- | 17 g | 25 g MP PP | 13 g C/17 g | XXX | |
| 04 | SB PP - | | SB PP | | |
| ML Film | Coated w | | | | |
| | 40.7 g ML | | | | |
| | Film | | | | |
| W/W8-2- | Coated w | — | 20 g C/12 g | | XXX |
| 04 | 40.7 g ML | | SB PP | | |
| ML Film | Film | | | | |

TABLE 13
Tests of Antimicrobial (AM) Finishes on Face Mask Fabrics

| | | | | Test Results | |
|---|---|---|---|---|---|
| | | | | % | |
| Composition/Finish | | | | Reduction | |
| Sample | | | | % | Log 10 |
| No. | Top | Middle | Inside | Reduction | Reduction |
| 15 | 17 g SB | TI Ch | 13 g C/17 S | 99.99+ | 4.75 |
| | FC + AM | MB PP | FC + AM | | |
| 35X | 25 g SB | TII Ch | 30 g HEC | 99.99+ | 4.75 |
| | FC | MB PP | AM Only | | |
| 35X | 25 g SB | TII Ch | 30 g HEC | 63.0 | 0.43 |
| Control | No Fin. | MB PP | No Fin. | | |
| 37X | 25 g SB | TII Ch | 13 g C/12 SB | 99.99+ | 4.75 |
| | FC | MB PP | AM Only | | |
| 37X | 25 g SB | TII Ch | 13 g C/12 SB | 99.99+ | 4.38 |
| Control | No Fin. | MB PP | No Fin. | | |

TABLE 14
Tests of Antimicrobial (AM) Finishes on Garment Fabrics

| | | | | Test Results | |
|---|---|---|---|---|---|
| | | | | % | |
| Description/Finish | | | | Reduction | |
| Sample | | | | % | Log 10 |
| No. | Top | Middle | Inside | Reduction | Reduction |
| 1 | 25 g SB | MP PP | 20 g C/17 g | Top: −7.3% | Top: −0.92 |
| | PP FC | Film | SB | Inside: | Inside: 3.43 |
| | | | AM Only | 99.963 | |
| 3 | 25 g SB | MP PP | 20 g C/17 g | Top: 84% | Top: 0.79 |
| | PP | | SB | Inside: | Inside: 3.22 |
| | FC + AM | | Latex + AM | 99.939 | |
| 7 | 25 g SB | MP PP | 13 g C/17 g | Top: −0.17 | Top: −1.25 |
| | PP | | SB | Inside: | Inside: 2.39 |
| | FC + AM | | FC + AM | 99.59 | |

TABLE 15
Protective Garment Samples Sent to China Quartermaster Institute

| | Description of Garment Fabrics |
|---|---|
| #3: | Outer Side (OS) Layer of 25 g Light Blue SB PP with |
| | FC + SARS AM (Finish IIIB) |
| | Center Layer of PP Microporous (MP) Film |
| | Body Side (BS) Layer of 20 g 60/40 C/PP on 17 g SB PP |
| | (CSN) with Latex + SARS AM (Finish IVA3) |
| #7: | Same as #3 except OS Layer has 25 g Dark Blue SB PP and |
| | BS has 13 g 60/40 C/PP on 17 g SB SB (Also has Fin. IIIB |
| | on OS & Finish IVA3 on BS |
| #29-1A: | Control for Sample 3 (same construction as #3 except |
| | No Protective Finishes) |
| #29-2A: | Control for Sample 7 (same construction as #7 except |
| | No Protective Finishes) |

TABLE 16
Face Mask Samples Sent to China Quartermaster Institute

Description of Face Mask Fabrics

Face Mask Fabrics Finished in China during August-September 2003

| | |
|---|---|
| #15: | Outer Side (OS) Layer of 17 g Phthalo Blue SB with FC + SARS AM |
| | (Finish IIB) |
| | Center Layer of Tantret ™ Charged 17 g MB PP |
| | Body Side (BS) Layer of 17 g White SB with FC + SARS AM (Finish IIB) |
| #15C1: | Control for Sample #15 with no finishes but with Charged MB in Center |
| #35X: | OS of 25 g Light Blue SB PP with FC only (Finish 1B) |
| | Center of Tantret ™ Charged 17 g MB PP |
| | BS of 30 g Hydroentangled 100% Cotton (HEC) with SARS AM only |
| | (Fin. IIB) |
| #35Y: | OS of 25 g Light Blue SB PP with FC + SARS AM (Finish IIIB) |
| | Center of Tantret ™ Charged 17 g MB PP |
| | BS of 30 g HEC with SARS AM only (Finish IIB) |
| #35C1: | Control for 35X and 35Y with No Finishes but with Charged MB in |
| | Center |
| #35C2: | Control for 35X and 35Y with No Finishes and Non-Charged MB in |
| | Center |
| #37X: | OS of 25 g Dark Blue SB PP with FC only (Finish 1B) |
| | Center of Tantret Charged 17 g MB PP |
| | BS of 13 g 60/40 C/PP on 17 g SB PP CSN with SARS AM only |
| | (Finish IB) |
| #37Y: | OS of 25 g Dark SB PP with FC + SARS AM (Finish IIIA) |
| | Center of Tantret Charged 17 g MB PP |
| | BS of 13 g 60/40 C/PP on 17 g SB PP with Latex + SARS AM |
| | (Finish IVA) |
| #37C1: | Control for 37X and 37Y but with a Charged MB PP in Center |

Non-Finished Face Mask Fabrics Prepared at TANDEC in November 2003

| | |
|---|---|
| #21A-18-1: | OS of 15 g Phthalo Blue SB PP |
| | Center of 18 g MB PP Charged by Tantret Technique I |
| | BS of 30 g HEC |
| #21A-18-1 Control: | Same as 21A-18-1 but with Non-Charged MB PP |
| #21A-25-5: | OS of 15 g Phthalo Blue SB PP |
| | Center of 25 g MB PP Charged by Tantret Technique I |
| | BS of 30 g HEC |
| #21A-25-5 Control: | Same as 21A-25-5 but with Non-Charged MB PP |
| #21-30-4: | OS of 15 g Phthalo Blue SB PP |
| | Center of 30 g MB PP with Laminate Charged by Tantret |
| | Technique II |
| | BS of 30 g HEC |
| #21-30-4 Control: | Same as 21-30-4 but with Non-Charged MB PP |
| | (Lam. Not Charged) |
| #21-30-3: | OS of 15 g Phthalo Blue SB PP |
| | Center of 30 g MB PP with Laminate Charged by Tantret |
| | Technique II |
| | BS of 13 g 60/40 C/PP on 12 g SB (CSN) |
| #21-30-3 Control: | Same as 21-30-3 but with Non-Charged MB PP |

TABLE 17
The Anti-bacteria Efficiency of the First Set of
Samples Tested by China Quartermaster Institute.

| | | anti-bacteria |
|---|---|---|
| | | efficiency, |
| Sample | Bacteria tested | % |
| 29-1A(control) | Yellow grape | 0 |
| | coccus, | |
| | ATCC No. 6538 | |
| 3 | Yellow grape | 99.95 |
| | coccus, | |
| | ATCC No. 6538 | |
| 37C1(control) | Yellow grape | 0 |
| | coccus, | |
| | ATCC No. 6538 | |
| 37X | Yellow grape | 0 |
| | coccus, | |
| | ATCC No. 6538 | |
| 37-Y | Yellow grape | 99.88 |
| | coccus, | |
| | ATCC No. 6538 | |
| 35C1(control) | Yellow grape | 0 |
| | coccus, | |
| | ATCC No. 6538 | |
| 35X | Yellow grape | 99.86 |
| | coccus, | |
| | ATCC No. 6538 | |
| 35Y | Yellow grape | 99.86 |
| | coccus, | |
| | ATCC No. 6538 | |
| 35C2 | Yellow grape | 0 |
| | coccus, | |
| | ATCC No. 6538 | |

TABLE 18
The Anti-bacterial Efficiency of Samples tested
per ATCC No. 6538 with Staphylococcus Aureus

| | |
|---|---|
| Samples | Controls |

| | anti-bacteria | | anti-bacteria |
|---|---|---|---|
| No. | efficiency | No. | efficiency |
| 3# | 99.96% | 29-1A | 0% |
| 7 | 0% | 29-2A | 0% |
| 35X | 99.90% | 35-C1 | 0% |
| 35Y | 99.90% | | |
| 35-C2 | 0% | | |
| 37X | 30.53% | 37-C1 | 0% |
| 37Y | 99.95% | | |
| 15 | 99.28% | 15-C1 | 0% |
| 21-30-4 | 19.51% | 21-30-4control | 0% |
| 21A-25-5 | 0% | 21A-25-5control | 0% |
| 21A-18-1 | 99.52% | 21A-18-1control | 0% |
| 21-30-3 | 0% | 21-30-3 control | 0% |

TABLE 19
The Anti-bacterial Efficiency of Samples tested per
ATCC No. 6538 with Staphylococcus Aureus using a Control
Sample which had to anti-bacterial Efficiency

| Samples | | | | |
|---|---|---|---|---|
| | anti- | Compared samples | | Control |
| | bacteria | | anti-bacteria | anti-bacteria |
| No. | efficiency | No. | efficiency | efficiency |
| 3# | 99.95% | 29-1A | 0% | 0 |
| 7 | 0% | 29-2A | 99.62% | 0 |
| 35X | 99.86% | 35-C1 | 0% | 0 |
| 35Y | 99.86% | | | |
| 35-C2 | 0% | | | |
| 37X | 0% | 37-C1 | 0% | 0 |
| 37Y | 99.88% | | | |
| 15 | 99.88% | 15-C1 | 82.84% | 0 |
| 21-30-4 | 70% | 21-30-4control | 62.37% | 0 |
| 21A-25-5 | 59.09% | 21A-25- | 72.73% | 0 |
| | | 5control | | |
| 21A-18-1 | 99.70% | 21A-18- | 36.60% | 0 |
| | | 1control | | |
| 21-30-3 | 74.72% | 21-30-3 | 81.89% | 0 |
| | | control | | |

### EXAMPLES OF ANTIMICROBIAL TREATMENTS OF FACE MASK, RESPIRATOR AND GARMENT FABRICS

A commercial microbiostatic agent for textile applications, which has been approved by the U.S. Environmental Protection Agency (EPA) is SIS 500 TEX produced by SiShield Technologies Inc., 5555 Glenridge Connector, Suite 200, Atlanta, Ga. 303342 (Email: SiShield@msn.net). According to the brochure published by SiShield Technologies, SiS 500 TEX is an antimicrobial organosilane quarternary amine, which may be applied to conventional textiles and to nonwovens by a number of techniques ranging from exhaustion from an aqueous bath, padding, spraying, kiss roller coating, etc. Some of the beneficial antimicrobial effects are:
inhibits the growth of odor causing bacteria,
prevents the growth of mold and mildew
eliminates the odor caused by human sweat on cloth
long lasting results (effective after 50 laundries)
compatible with many processes and conditions, including pH's from 3 to 10
by minimizing mold decay of skin cells, interrupts Dust mite life cycle by eliminating their nutrient source
malodors are attacked at their source by preventing decay
can be incorporated into the manufacture of a variety of materials.

More recently SiShield has developed SiShield SiS 200 SARS (SiShield Technologies File No. 221), which is a proprietary compound, approved by the U.S. EPA to combat the Serve Acute Respiratory Syndrome (SARS) virus. According to its MSDS dated 01/02/03, the ingredients include 3-(Trimethoxysilyl)propyldi, methyloctadecyl ammonium chloride, and four other proprietary ingredients. The family name is an organosilane. According to the SiShield promotional literature, both SIS 500 TEX and SiShield SiS 200 SARS chemically react with textile fibers and may be applied from aqueous treatment baths by exhaustion, padding, foam application, roller coating, spraying, etc. and that an active add-on of 4% on the weight of the fabric after drying and curing is sufficient with both of the antimicrobials and that latex binders are not necessary keep the agents from migrating or leaching from the fabrics. Nevertheless, these inventors prefer to apply these agents along with a soft latex binder such as Hystretch V-29 supplied by Noveon, Inc., Cleveland, Ohio, to further assure that minimal or no migration of the antimicrobial agent occurs to the skin of the wearer or is respirated by the wearer. These inventors prefer to apply a solids add-on of 5-20% of latex (with a preferred latex add-on of 8-12%). Since some of the SiShield SIS 500 TEX or SiShield SiS 200 SARS may be at least partially encapsulated by the latex binder, these inventors prefer to increase the add-on of the active concentrate on the fabric filter component(s) being treated from 4 to 6%, when applied from either a foam, padding, spraying or kiss roll application. After applying the combined latex and SiS 200 SARS from an aqueous bath, sufficient heat, temperature, and dwell time in an oven or other type of drying system is required to first evaporate the water from the fabric, leaving the dried antimicrobial agent and latex binder. After drying the fabric at 105-110° C., the SiShield antimicrobial agent and the latex typically require exposure at 130° C. for 2 minutes to be cured and fixed within the fabric structure.

### DESCRIPTION OF EXEMPLARY EMBODIMENTS OF THE INVENTION OF FACE MASK AND RESPIRATOR INVENTION

The invention consists of a minimum of two different layers. The outer layer may be any woven, knitted or nonwoven fabric, or sufficiently porous film fabric for the required end-use made from any fiber type, and may be of any texture, color or pattern. However in an example described in this invention disclosure, the outer layer is a colored spunbond (SB) polypropylene (PP), typically by addition of color concentrate of pigment in a base polymer. The middle layer may be any fibrous material which may or may not be electrostatically charged (e. g., melt blown PP) and or given an antimicrobial treatment.

In one of the examples described herein, the layer behind the SB outer colored layer is a cotton-containing fabric in which two types of cotton-containing fabrics were designed to demonstrate aspects of this invention. The first type of cotton was a 30 g/m² (gsm) hydroentangled 100% cotton non-woven with an open mesh. The second type demonstrated was a cotton/PP staple fiber web which-was thermally bonded to the natural (white) SB PP on the SB machine either during SB spinning or laminated by any number of means after SB production. The cotton nonwoven behind the SB PP may be treated with any type of non-durable or durable antimicrobial finish to kill bacteria which may penetrate the outer layer when the fabric is worn as a face mask or respirator, for example. Non-leachable durable antimicrobial agents have the advantage of being less likely to diminish in microbial deactivating capacity as they are depleted from the fabric and because there should be less likelihood of causing skin irritation to the wearer, or result in other toxic or undesirable effects on the wearer.

The finishes may be held in the fabric by chemical or physical binders, but finishes that are either physically bound and/or chemically reacted with the fiber have the advantage of being safer and lasting longer since such antimicrobial compounds are much less likely to leach out of the fabric and cause skin irritation or harmful or irritating effects if absorbed through the skin or if inhaled. Examples of durable antimicrobial compounds that have been chemically grafted to cotton, polyolefins, nylons and other fibers are described in the literature by Gang Sun et al. (Textile Chemists and Colorists 30, No. 6, pp 26-30, 1999; Textile Chemists and Colorists 31, pp 31-35, 1999; Ind. Eng. Chem. Res. 40, pp 1016-1021, 2001) and by Yuyu Sun et al. (Journal of Applied Polymer Science 80, pp 2460-2467, 2001; Journal of Applied Polymer Science 81, pp 617-624, 2001; Journal of Applied Polymer Science 81, 1517-1525, 2002; Journal of Polymer Science: Part A: Polymer Chemistry 39, pp 3073-3084, 2001; Journal of Polymer Science: Part A: Polymer Chemistry 39, pp 3348-3355, 2001; and Journal of Applied Polymer Science 88, pp 1032-1039, 2003).

Examples of three or more ply materials that may be used as filters may include any of the above described two-ply constructions and other embodiments of this invention with any of the two-ply constructions being backed by any type of woven, knitted, nonwovens or sufficiently porous film material which in the case of face masks or respirators may be worn on the side in contact with the face. Examples developed towards reducing this invention to practice include SB PP fabric, hydroentangled cotton fabric, and cotton/PP staple fiber webs bonded to SB PP. Preferred, but by no means limiting, embodiments include Examples A, B, C, D, E, F and G below. In Examples A through F, the laminate component layers are not bonded together, with the exception of Examples B, C, D, E, F and G, in which the carded cotton/PP staple fiber web is thermally-point-bonded to the natural (white) SB PP web during melt spinning of the SB filament web on the SB manufacturing line. However this component is referred to as a Cotton-Surfaced Nonwoven (CSN) and was laminated after production on the SB line with the other component layers and essentially treated as a single CSN composite layer.

Generally, face masks (e.g. surgical face masks and dust masks) are not bonded together and are only bonded on the edges of the face mask being fabricated by either sewing, or preferably by ultrasonic bonding. Nevertheless, the face mask laminates may be thermally or ultrasonically bonding together by a “spot welding” technique which does not fuse enough of the laminate together to excessively increase the pressure drop across the filter and make it difficult for one to breathe easily through the fabric, or to cause pin hole to form in the laminate and increase the risk of harmful particles through the face mask. The exception is Example F in which the laminate layers may be thermally fused together to produce a pre-formed cup-shaped mask or respirator, which may be held firmly, yet comfortably against the mouth to ensure that no or minimal leakage occurs where the edges of the cup-shaped mask contacts the human face. In fact a non-air-leaking rubbery or spongy layer may be attached around the edges of the cup mask to assure both a comfortable fit and non-leakage. Typically to produce a cup mask with the required filtration efficiency and not too much pressure drop, coarser, yet thicker laminate components, including MB media with larger fiber diameters and pores, may be used so that the final overall thermally bonded or spot thermally bonded or spot ultrasonically three-dimensionally shaped mask meets the required end-use specifications in terms of filtration efficiency, pressure drop and proper fitting to the human or animal face. Alternatively, 3-D shapes may be fabricated without fusing or shaping a cup-type mask in a mold, e.g. by ultrasonically or otherwise seaming and bonding the structure together.

In all of the examples described herein and in other embodiments of the invention, one or more odor or toxic gas absorbing component layers may be incorporated into the filter structures at appropriate locations within the cross-section of the filter to provide additional protection and comfort to the wearer, without excessive pressure drop for the particular hazardous environment.

It will be understood that various changes in the details, materials, and arrangements of the parts which have been described and illustrated above in order to explain the nature of this invention may be made by those skilled in the art without departing from the principle and scope of the invention as recited herein.

### Example A

1) Outer layer of colored SB PP, which may or may not be treated with an alcohol, oil or water repellent finish, which may or may not be electrostatically charged, and which may or may not be treated with an antimicrobial agent.

2) Melt Blown PP behind layer 1 which may or may not be electrostatically charged and may or may not be treated with an antimicrobial agent.

3) Inner layer of cotton-based porous hydroentangled nonwoven worn next to the face, which may also be treated with a chemically bonded antimicrobial compound.

### Example B

1) Outer layer of colored SB PP which may or may not be electrostatically charged or may or may not be treated with a repellent finish or with an antimicrobial agent.

2) MB PP behind layer 1 in Example B, which may or may not be electrostatically charged and which may or may not be treated with an antimicrobial agent.

3) Inner layer of cotton/PP staple fiber web thermally bonded to a white SB PP (CSN) with the SB PP side adjacent to layer 2 in Example B in which the cotton side is adjacent to the face and may or may not be treated with a non-leachable (non-migrating) antimicrobial agent.

### Example C

1) Outer layer of colored SB PP which may or may not be treated with an antimicrobial agent.

2) Electrostatically charged MB PP behind layer 1 in Example C.

3) Inner layer of cotton/PP staple fiber web thermally bonded to a SB PP (CSN), in which one or both components may or may not be treated with an antimicrobial agent, and in which the cotton side is adjacent layer 2 in Example C and the SB PP is worn against the face.

### Example D

Examples A, B and C above in which a fourth layer of woven, knitted, nonwoven, or porous film to be worn against the human or animal face behind the last layer in the above examples.

### Example E

Examples A, B, C and D above in which component layers containing activated carbon powders, activated carbon fibers and/or activated carbon nanofibers, may be incorporated in one or more layers across the thickness of the filter to absorb odors or toxic gases per the end-use requirements of the filter.

### Example F

In examples A, B, C, D and E above, electrospun or other types of nanofiber webs of any fiber type may replace the MB PP web of any fiber type or may form a thin coating over the MB web to further enhance the filtration efficiency without exceeding the pressure drop requirements of the filter for the particular end-use.

### Example G

Thermally-bonded, ultrasonically molded, or adhesively molded three-dimensionally shaped cup filters or three-dimensionally shaped filters may be fabricated by 3-D shaping or seaming to cover the nose, mouth and nose or the entire head or upper torso of the human or animal being protected.

### DESCRIPTION OF EXEMPLARY EMBODIMENTS OF THE PROTECTIVE GARMENT INVENTION

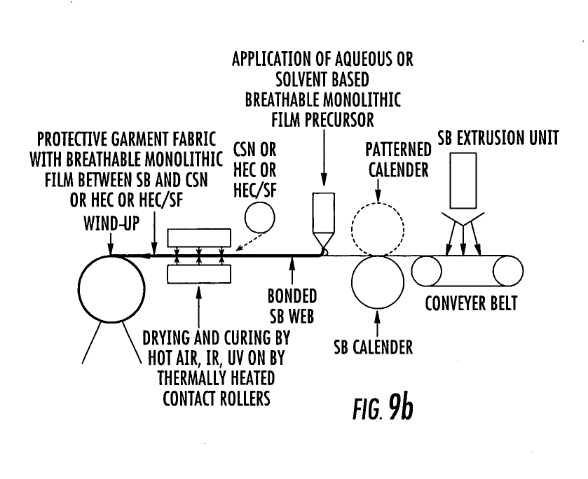

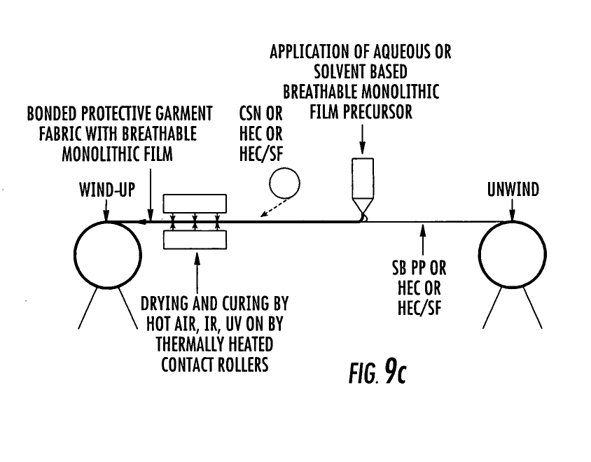

The invention comprises a minimum of two different layers. The outer layer may be any woven, knitted or nonwoven fabric, or sufficiently breathable film for the required end-use made from any fiber type, and may be of any texture, color or pattern. However in an example described in this invention, the outer layer is a colored (typically of addition of color concentrate of pigment in a base polymer) spunbond (SB) polypropylene (PP). The inner layer may be any breathable material which may in itself serve as a protective barrier against harmful chemical liquids or vapors, which may or may not be have also been given an antimicrobial treatment. In one of the examples described in this invention, the layer behind the SB outer colored layer is a cotton-containing fabric in which two types of cotton-containing fabrics were designed to demonstrate aspects of this invention as illustrated in FIG. 10. The first type of cotton is a 30 g/m² (gsm) hydroentangled cotton-based fabric with an open mesh. The second type demonstrated was a cotton/PP staple fiber web which was thermally bonded to the colored SB PP in the SB machine either during SB spinning or laminated by any number of means after SB production. As with the inventive face mask laminate, cotton-based fabric behind the SB PP may be treated with any type of non-durable or durable antimicrobial finish to kill bacteria which may penetrate the outer layer when the fabric. Non-leachable durable antimicrobial agents have the advantage of being less likely to diminish in microbial deactivating capacity as they are depleted from the fabric and because there should be less likelihood of causing skin irritation to the wearer, or result in other toxic or undesirable effects on the wearer. The finishes may be held in the fabric by chemical or physical binders, but finishes that are either physically bound and/or chemically reacted with the fiber are preferred in this invention since such antimicrobial compounds are much less likely to leach out of the fabric and cause skin irritation or harmful or irritating effects if absorbed through the skin or if inhaled. Examples of durable antimicrobial compounds that have been chemically grafted to cotton, polyolefins, nylons an other fibers are described in the literature by Gang Sun et al. (Textile Chemists and Colorists 30 No. 6, pp 26-30, 1999; Textile Chemists and Colorists 31, pp 31-35, 1999; Ind. Eng. Chem. Res. 40, pp 1016-1021, 2001) and by Yuyu Sun et al. (Journal of Applied Polymer Science 80, pp 2460-2467, 2001; Journal of Applied Polymer Science 81, pp 617-624, 2001; Journal of Applied Polymer Science 81, 1517-1525, 2002; Journal of Polymer Science: Part A: Polymer Chemistry 39, pp 3073-3084, 2001; Journal of Polymer Science: Part A: Polymer Chemistry 39, pp 3348-3355, 2001; and Journal of Applied Polymer Science 88, pp 1032-1039, 2003).

Other facile methodologies have been developed for covalently bonding antibacterial polycations such as poly(vinyl-Npyridium bromide) (hexyl-PVP) to a wide range of organic polymers, as well as to glass. Glass slides covalently bonded to hexyl-PVP were found to kill greater than 99% of air borne bacteria (Tiller, et al., Proc Natl Acad Sci9, pp 5981-5985). In a follow-up study, five commercial, inherently non-bactericidal polymers, which were covalently bonded with hexyl-PVP, were found to kill 90-99% of Gram-positive and Gram-negative bacterial through either water or air contact on their surfaces. Furthermore, these modified materials were shown to kill bacterial resistant strains of bacteria, essentially as readily as non-bacterial resistant strains (Tiller et al., Biotechnology and Bioengineering 79, pp 466-471, 2002). Also Lin et al. (Biotechnol. Prog 18, pp 1082-1086, 2002) demonstrated that amino glass slides when reacted with polyethylenimines (PEls) were highly bactericidal toward both Gram-negative and Gram-positive pathogenic bacteria which contacted these modified materials through either air or water-borne media. Furthermore, they demonstrated that 96% of S. aureus cells were killed within a 5-minute contact time with Fe₃O₄ nanoparticles reacted with hexyl-PVP. In another study, Aymonier, et al. (Chem. Commun., pp 3018-3019, 2002) showed that it was not necessary to covalently bond polycations to the surface of a substrate for it the antimicrobial agent to be non-leachable, in that “hybrids of silver nanoparticles of 1 to 2 nm in size with highly branched amphiphilically modified polyethyleneimines adher[ed] effectively to polar substrates providing environmentally friendly antimicrobial coatings.” All of these studies cited above provide examples of how non-leachable (non-migrating) antibacterial agents may be attached to any of the components used in the various embodiments of this invention. Furthermore safe and effective leachable biocides may also be incorporated into or between any of the components in these protective layered constructions.

The first line of defense in breathable protective apparel is a tough abrasion router shell fabric which has been treated with a fluorochemical (FC) repellent-based finish to impart a non-wetting surface to water, oil, alcohol and other organic solvents. Then breathable films that may be incorporarted into 2 or multi-ply structures include both porous and non-porous monolithic (ML) films. ML films generally absorb moisture from the wearer and provides both the transfer of moisture away from a person's body and results in evaporative cooling when the moisture passes through the non-pervious film and evaporates into the surroundings. Some commercial ML films use thermoplastic polyurethane (TPU) resins such as Estane®, COPAs like PEBAX® and COPE resins like Hytrel® to make breathable barrier films. Microporous (MP) films serve as barriers to liquids in that they have small torturous pore channels through the film which are too small for most liquids such as water, body fluids and many organic chemical to pass through the films as liquids, put allow moisture vapor to escape and provide thermal comfort for the wearer. Examples include Exxaire®, a polyethylene based microporous (MP) film produced by Tredegar Films, Tetratex™; a MB PTFE film produced by Tetratec Corporation; and Aptra Classic™ MP PP film produced by RKW US, Inc., and other types of MP films.

To provide an extra measure of safety from the penetration of hazardous chemical or biological agents, the continuous ML films may be used in combination with MP films in which the ML film or films are located downstream from the threat agent behind the MP film to serve as an impervious barrier to any harmful chemical or biological agent that may have penetrated the MP film. The ML film may be laminated directly to the MP film by thermal or ultrasonic bonding or by adhesives applied in a sintered or dot coating, as is used to fuse interlinings to textiles, in the case of bonding ML films to MP PTFE films. The ML and MB films may be adhered together directly or may be separated by one or more fibrous or porous film structures. More than one layer of ML or MP films may be also be used to reinforce the barrier performance of protective fabrics containing only ML or MB films or in combinations of MP and ML films. However, multiple layers in protective clothing structures of MP and ML or combinations of MP and ML breathable films will reduce the moisture vapor transport rate (MVPR) through the protective garment and will reduce the length of time that an individual can work with acceptable thermal comfort in a high threat environment.

Examples of three or more ply materials that may be used as chemical and microbial barrier and also possibly as biocides when treated with antimicrobial agents may include any of the above described two-ply constructions and other embodiments of this invention with any of the two-ply constructions being backed by any type of type of woven, knitted, nonwoven or sufficiently breathable film.

It will be understood that various changes in the details, materials, and arrangements of the parts which have been described and illustrated above in order to explain the nature of this invention may be made by those skilled in the art without departing from the principle and scope of the invention as recited herein. Preferred, but by no means limiting, embodiments include the following examples:

### Example H

1) Outer layer of colored (pigmented) spunbond (SB) polypropylene (PP), which may or may not be treated with a repellent finish and may or may not be treated with an antimicrobial agent.

2) Breathable MP or ML film or multiple layers of each type or a combination of MP and ML films behind outer SB layer in Example A, which may or may not be treated with an antimicrobial agent.

3) Inner layer of cotton-based porous hydroentangled cotton nonwoven worn next to the body which may also be treated with a chemically bonded antimicrobial compound, which may also be co-applied with a latex binder to reinforce the nonwoven and minimize linting of the cotton onto the skin or clothing of the wearer.

### Example I

1) Outer layer of colored SB PP which may or may not be treated with a repellent finish or an antimicrobial agent.

2) Breathable film ML or MP or a combination of ML and MP films behind the outer layer in Example B, which may or may not be treated with an antimicrobial agent.

3) Inner layer of cotton/PP staple fiber web thermally bonded to a SB PP (referred to as a Cotton-Surfaced Nonwoven [CSN]) with the SB PP side adjacent to layer 2 in Example B in which the cotton may or may not be treated with non-leachable antimicrobial agent.

### Example J

1) Outer layer of colored SB PP which may or may not be treated with an antimicrobial agent.

2) Breathable film ML or MP film or a combination of MP and ML films behind the outer layer in Example C, which may or may not be treated with an antimicrobial agent.

3) Inner layer of cotton/PP staple fiber web thermally bonded to a SB PP (referred to as a Cotton-Surfaced Nonwoven [CSN] in which one or both components may or may not be treated with an antimicrobial agent, and in which the cotton side is adjacent layer 2 in Example C and the SB PP is worn against the body.

### Example K

1) Outer layer of colored SB PP which may or may not be treated with an antimicrobial agent.

2) Breathable film (ML or MP) behind the outer layer in Example C.

3) Inner layer of cotton/PP staple fiber web thermally bonded to a SB PP, in which one or both components may or may not be treated with an antimicrobial agent, and in which the cotton side is adjacent layer 2 in Example D and the SB PP is worn on the side towards the body.

2) Inner layer of a woven, knitted, or nonwoven or porous film fabric behind layer 3 in Example D in which layer 4 is worn against the human body.

### Example L

1) Outer layer of breathable film (ML or MP) which may or may not be treated with an antimicrobial agent.

2) Second or multiple layers of breathable films (ML or MP) which may or may not be treated with antimicrobial agents, which may be laminated adjacent to each other or may have woven, knitted or nonwoven layers between one or more stacks of breathable film.

### Example M

Examples A, B, C, D and E above in which component layers containing activated carbon powders, activated carbon fibers and/or activated carbon nanofibers, may be incorporated in one or more layers across the thickness of the protective fabric to absorb odors or toxic gases per the end-use requirements of the fabric.

### Example N

In Examples A through F above, melt blown microfiber webs may be incorporated to add additional barrier performance and electrospun or other types of nanofiber webs of any fiber type may replace the MB PP web of any fiber type or may form a thin coating over the MB web to further enhance the barrier performance of the protective apparel.

Furthermore, it should be noted that none of the layers in the above examples or other embodiments of this invention have to be bonded together in that they may be adjoined at the seams during fabrication by any number of techniques to include but not limited to sewing (with covering by plastic tape which is known as hot-air taping), ultrasonic bonding, thermal bonding, adhesive bonding with breathable adhesives that may be applied by a number of different methods. Also, some layers may be bonded together in a continuous or pattern-bonded style, while other component layers may or may not be bonded. Some layers may be laminated and thermally bonded during spunbond or melt blown or composite spunpond/melt blown production. Thus the entire fabric ensemble may be constructed in one continuous manufacturing operation or in stages. Fabrication into garments would most likely be done in a separate converting operation, but conceivably could be accomplished in one continuous manufacturing operation.

It will be understood that various details of the invention may be changed without departing from the scope of the invention. Furthermore, the foregoing description is for the purpose of illustration only, and not for the purpose of limitation, as the invention is defined by the claims as set forth hereinafter.

1. A barrier fabric including at least one web comprising an electrostatically charged melt blown (MB) fibers nonwoven web treated with a fluorochemical (FC) having a weak cationic emulsifier to reduce surface energy of the fibers so as to minimize penetration and wetting by oily mists and to thereby preserve the effectiveness of electrostatic charges applied to the fibers.

2. The barrier fabric of claim 1 comprising a fluorochemical (FC) with a weak cationic emulsifier to avoid neutralizing electrostatic charges.

3. The barrier fabric of claim 2 wherein the fluorochemical (FC) with a weak cationic emulsifier comprises REPEARL 45 and REPEARL 8095 brand chemicals available from Mitsubishi International Corporation.

4. The barrier fabric of claim 1 also containing an antimicrobial agent that may either be incorporated into the fiber polymer melt during fiber formation or adhered to the melt blown (MB) fibers with a latex or adhered to the fibers by grafting or covalent bonds.

5. The barrier fabric of claim 1 in which polycations are added to the fiber polymer melt or grafted to the fibers.

6. The barrier fabric of claim 1 in which poly(vinyl-Npyridium bromide is added to the fiber polymer melt or grafted to the fibers.

7. The barrier fabric of claim 1 in which an organosilane is added to the fibers.

8. The barrier fabric of claim 1 in which SiShield SiS 200 SARS or SiShield SIS TEX 500 are added to the fibers.

9. A two-layer barrier fabric comprising at least one barrier layer which is respirable for use as a face mask or respirator and which contains one or more protective finishes.

10. A two-layer barrier fabric of claim 9 in which component layers containing activated carbon particles, or activated carbon fibers, or activated carbon nanofibers, or other absorbents or superabsorbents may be incorporated in one or more layers across the thickness of the filter to absorb odors or toxic gasses per the end-use requirements of the filter.

11. A two-layer barrier of claim 9 in which electrospun or other types of nanofiber webs of any fiber may replace the MB PP web or form a coating over the MB web to further enhance the filtration efficiency without exceeding the pressure drop requirements of the filter for the particular end-use.

12. The two-layer barrier fabric of claim 9 which contains a fluorochemical (FC) to repel liquids in at least one layer thereof.

13. The two-layer barrier fabric of claim 9 which contains an antimicrobial compound or treatment to kill microorganisms in at least one layer thereof.

14. A two-layer fabric of claim 1 also containing an antimicrobial agent that may either be incorporated into the polymer during fiber or film formation or adhered to the fibers or film with a latex or adhered to the fibers or film by grafting or covalent bonds.

15. The two-layer barrier fabric of claim 13 which contains in at least one layer containing polycations as for example, poly(vinyl-Npyridium bromide; or organosilanes, for example SiShield SiS 200 SARS or SiShield SIS TEX 500.

16. The two-layer barrier fabric of claim 13 comprising an absorbent layer to be worn near the body for comfort and for better uptake of protective finish.

17. The two-layer barrier fabric of claim 9 comprising a porous layer to be worn near the body for comfort and which may contain a wetting agent to improve moisture transport

18. The two-layer barrier fabric of claim 9 comprising an absorbent layer to be worn near the body for comfort and for better uptake of protective finish.

19. The two-layer barrier fabric of claim 16 which is made of natural absorbent fiber selected from the group consisting of cotton, flax, hemp, ramie, and kenaf or from protein fibers selected from the group consisting of wool or silk.

20. The two layer barrier fabric of claim 16 in which a hydroentangled cotton containing nonwoven is coated with a ML breathable film, for example Permax BB2415 HMVT breathable coating

21. The two-layer barrier fabric of claim 18 which is made of natural absorbent fiber selected from the group consisting of cotton, flax, hemp, ramie, and kenaf or from protein fibers selected from the group consisting of wool or silk.

22. A multi-ply barrier fabric comprising a respirable barrier fabric and which comprises a finish in one or more layers to repel and/or to deactivate or kill microorganisms.

23. A multi-layer barrier fabric of claim 9 in which component layers containing activated carbon particles, or activated carbon fibers, or activated carbon nanofibers, or other sorbents, or superabsorbents may be incorporated in one or more layers across the thickness of the fabric to absorb odors or toxic gasses per the end-use requirements of the barrier fabric.

24. A multi-layer barrier of claim 9 in which electrospun or other types of nanofiber webs of any fiber may replace the MB PP web or form a coating over the MB web to further enhance the filtration efficiency without exceeding the pressure drop requirements of the filter for the particular end-use.

25. A two-layer barrier fabric which has at least one barrier fabric layer which is impermeable to liquids such as water and body fluids, but which allows the transport of moisture vapor through the micropores or by chemical absorption of water through a monolithic membrane (MM).

26. A two-layer barrier fabric of claim 25 in which component layers containing activated carbon particles, or activated carbon fibers or activated carbon nanofibers may be incorporated in one or more layers across the thickness of the fabric to absorb odors or toxic gasses per the end-use requirements of the fabric.

27. A two-layer barrier of claim 25 in which a MB web of any fiber may incorporated enhance the personal protection of the barrier fabric.

28. A two-layer barrier of claim 25 in which electrospun or other types of nanofiber webs of any fiber may incorporated as a separate web or as a covering on a MB web or other layer to enhance the personal protection of the barrier fabric.

29. The two-layer barrier fabric of claim 25 comprising a porous layer to be worn near the body for comfort and which may contain a wetting agent to improve moisture transport.

30. A multi-ply barrier fabric with a microporous (MP) or monolithic (ML) breathable film or comprising a combination of the two.

31. A multi-ply barrier fabric of claim 30 in which component layers containing activated carbon particles, or activated carbon fibers or activated carbon nanofibers may be incorporated in one or more layers across the thickness of the fabric to absorb odors or toxic gasses per the end-use requirements of the barrier fabric.

32. A multi-layer barrier of claim 30 in which a MB web of any fiber may incorporated enhance the personal protection of the barrier fabric.

33. A multi-layer barrier of claim 30 in which electrospun or other types of nanofiber webs of any fiber may incorporated as a separate web or as a covering on a MB web or other layer to enhance the personal protection of the barrier fabric.

34. The multi-layer barrier fabric of claim 30 comprising a porous layer to be worn near the body for comfort and which may contain a wetting agent to improve moisture transport.

35. A multi-layer barrier fabric of claim 25 in which an antimicrobial compound is added to the fiber spinning melt or solution or added to the breathable film layer or to one or more other layers of the fabric.

36. The multi-ply barrier fabric of claim 30 in which an antimicrobial compound is added to the fibrous spinning melt or solution or added to the breathable film layer or to one or more other layers of the fabric.

37. The multi-layer barrier fabric of claim 13 which contains in at least one layer containing polycations as for example, poly(vinyl-Npyridium bromide; or organosilanes, for example SiShield SiS 200 SARS or SiShield SIS TEX 500.

38. The two-layer barrier fabric of claim 25 containing an absorbent fiber to be worn against the body for better comfort and uptake of protective finishes.

39. The multi-ply barrier fabric of claim 30 containing an absorbent fiber to be worn against the body for better comfort and uptake of protective finishes.

40. The multi-ply fabric of claim 30 comprising a cotton-surfaced spunbond fabric coated with a breathable ML film, for example, Permax BB2415 HMVT Breathable Coating.

41. The multi-ply fabric of claim 30 comprising an outer fabric of spunbond PP coated with a breathable ML film, an interior layer of MP film, and a cotton-containing body-side layer

42. The multi-ply fabric of claim 30 comprising an outer fabric of spunbond PP coated with a breathable ML film, an interior layer of MP film, and a cotton-containing body-side layer

43. The multi-ply fabric of claim 30 comprising an outer fabric of spunbond PP coated with a breathable ML film, an interior layer of MP film, and a porous fabric on the body side that may be treated with a wetting agent for better water transport

44. The multi-ply fabric of claim 30 comprising an outer fabric of spunbond PP coated with a breathable ML film, an interior layer of MP film, and a spunbond body side layer.

45. The multi-ply fabric of claim 21 comprising a spunbond and melt blown laminate or a spunbond/melt blown/spunbond laminate coated on at least one side with a ML breathable film.

46. The two-layer barrier fabric of claim 35 containing an absorbent fiber to be worn against the body for better comfort and uptake of protective finishes.

47. The multi-ply barrier fabric of claim 36 containing an absorbent fiber to be worn against the body for better comfort and uptake of protective finishes.

48. A respirable face mask or respirator comprising the barrier fabric of claim 1.

49. A respirable face mask or respirator comprising the barrier fabric of claim 9.

50. A respirable face mask or respirator comprising the barrier fabric of claim 22.

51. A respirable face mask or respirator comprising the barrier fabric of claim 25.

52. A respirable face mask or respirator comprising the barrier fabric of claim 30.

53. A breathable protective garment comprising the barrier fabric of claim 1.

54. A breathable protective garment comprising the barrier fabric of claim 9.

55. A breathable protective garment comprising the barrier fabric of claim 22.

56. A breathable protective garment comprising the barrier fabric of claim 25.

57. A breathable protective garment comprising the barrier fabric of claim 30.
